(19) United States
(12) Patent Application Publication
(10) Pub. No.: US 2026/0309843 A1
(43) Pub. Date: Oct. 8, 2026

(54) MINIMIZING RADAR TRANSMISSION LOSS THROUGH COATINGS OF VEHICLE PARTS WITH ADDITIONAL RADAR CORRECTING LAYERS

(71) Applicant: PPG Industries Ohio, Inc., Cleveland, OH (US)

(72) Inventors: Eldon Lorenzo Decker, Gibsonia, PA (US); Scott Joseph Moravek, Mars, PA (US)

(73) Assignee: PPG Industries Ohio, Inc., Cleveland, OH (US)

(21) Appl. No.: 19/482,314

(22) PCT Filed: May 9, 2024
(86) PCT No.: PCT/US2024/028468

§ 371 Date: Nov. 7, 2025

Related U.S. Application Data
(60) Provisional application No. 63/501,739, filed on May 12, 2023.

(51) Int. Cl. G01S 7/40; G01S 7/04; G01S 7/41; G01S 13/88

(52) U.S. Cl. CPC G01S 7/4052; G01S 7/04; G01S 7/412; G01S 13/88

(57) ABSTRACT

A computer-implemented method can include receiving measured radar transmission loss values of a vehicle section with an applied coating over a range of frequencies and generating a plurality of trial variables for hypothetical section stacks having expected signal (radar) transmission loss. The method can also include adjusting the plurality of trial variables of various hypothetical stacks until identifying a hypothetical stack that matches the real measurements. The system can be further configured to perform various computational optimization routines to identify an appropriate radar correcting layer that acceptably minimizes the actual transmission loss of the radar transmissive section.

### CROSS-REFERENCE TO RELATED APPLICATIONS

The present invention claims the benefit of priority to U.S. Provisional Application No. 63/501,739, filed on May 12, 2023, the entire content of which is incorporate herein by reference.

### BACKGROUND OF THE DISCLOSURE

### 1. Technical Field

The present disclosure relates to systems and methods for minimizing signal loss through applied coatings.

### 2. Background and Relevant Art

The use of radar is becoming ubiquitous in modern transportation, such as with passenger vehicles, as well as a wide variety of autonomous, or unmanned objects or vehicles, such as land, water, or airborne drones. The use of radar is expected to increase as manufacturers make additional advances in driver assistance systems. Vehicles of these types generally use radar or other detection systems for driver detection systems, such as adaptive cruise control, automatic braking, and the like.

Driver assistance systems generally include various signaling components, such as signal transceivers and/or sensors located outside of vehicles or hidden in the body of the vehicles to identify obstacles, pedestrians, other vehicles, weather, etc. Manufacturers generally optimize the signaling components for maximum object detection capability. When vehicles require repainting (e.g., damage, fading, etc.), however, identifying the right color is only part of the problem since the new paint coating layer might have adverse effects on the signaling components. In particular, radar (or other signaling system) performance can be hindered by the new coating layers positioned over the signaling components, i.e., a “radar transmissive section” of a particular vehicle or object. Such factors can include signal loss due to changes in relative electric permittivity and/or thickness of the coating layers. Signal transmission can be adversely affected by a number of factors related to the various chemical compositions of the layers, including filler materials or pigments added for visual or textural effects.

Accordingly, there are a number of considerations in the art that can be addressed.

### BRIEF SUMMARY

The present disclosure provides systems, methods, and computer program products for modeling radar correcting layers that enable a newly coated object to meet a radar compliance requirement. For example, a user desiring to coat an object can perform various modeling techniques to identify various transmission loss characteristics of a substrate (e.g., a transmissive section of an object). The user can also model various hypothetical coating stacks to ascertain an expected coating arrangement about the object, to predict a signal transmission loss through the hypothetical coating stacks and transmissive section of the object. The user can further model various radar correcting layers that are likely to minimize the predicted signal transmission loss.

For example, a computer-implemented method of the present disclosure can include receiving, at a computer system, radar transmission loss values corresponding to a radar transmission loss measurement of a radar transmissive section of an object, wherein the received radar transmission loss values comprise measurements taken of a radar signal passed through the radar transmissive section over a range of frequencies from 1 GHz to 300 GHz. The method can also include generating a plurality of trial variables in the form of permittivity values and thickness values corresponding to a hypothetical radar transmissive section, the hypothetical radar transmissive section comprising a hypothetical section stack having an associated set of radar transmission loss values within the range of frequencies from 1 GHz and 300 GHz. In addition, the method can include adjusting one or more of the trial variables to create a set of predicted radar transmission loss values through the hypothetical section stack over a range of frequencies from 1 GHz to 300 GHz, wherein the predicted versus measured radar transmission loss values are within a Root Mean Square Error (RMSE) of less than 0.1 dB. Furthermore, the method can include using the one or more adjusted trial variables, performing a computational optimization routine via the computer system to predict a property of a radar correcting layer, such that the predicted radar correcting layer, when added to the hypothetical section stack, reduces a predicted radar transmission loss of the hypothetical stack to meet a radar compliance requirement. Still further, the method can include generating output instructions for displaying the predicted radar correcting layer to an end-user.

Additional or alternative configurations include a system that can include a processor, and a computer-readable storage medium, the computer-readable storage medium having stored thereon computer-readable instructions that, when executed, cause the system to receive radar transmission loss data over a measured frequency from 1-300 GHz, such as 60 GHz and 90 GHz for i) a radar transmissive section of a physical object, and ii) a plurality of arrangements of one or more calibration layers applied about the radar transmissive section, wherein the radar transmission section comprises a substrate and one or more coating layers applied thereto, and each calibration layer has a permittivity value that is the same. The system can also be configured to generate a plurality of predicted transmission loss values from a plurality of trial variables in the form of permittivity values and thickness values, the predicted transmission loss values corresponding to i) a hypothetical section stack, and to ii) the hypothetical section stack combined with each of the arrangements of one or more calibration layers, wherein the hypothetical section stack comprises a plurality of hypothetical coating layers applied to a hypothetical substrate of a hypothetical transmissive section of a hypothetical object. In addition, the system can be configured to adjust one or more of the trial variables to create a calculated radar transmission loss value at the measured frequency for i) the hypothetical section stack, and ii) a combination of each arrangement of one or more calibration layers and the hypothetical section stack, wherein the calculated versus received radar transmission loss values are within a root mean square error of less than 0.1 dB. Furthermore, the system can be configured to use the adjusted trial variables to perform a computational optimization routine via the computer system to predict a property of a radar correcting layer, such that the predicted radar correcting layer, when added to the hypothetical section stack, reduces the predicted radar transmission loss to meet a radar compliance requirement. Still further, the system can be configured to provide an output of the predicted radar correcting layer to an end-user.

Further configurations of the present disclosure include a computer-implemented method of determining a set of one of more radar correcting layers for addressing a radar transmission loss of a radar transmissive section of an object. For example, the method can include receiving radar transmission loss data over a measured frequency from 1-300 GHz, such as 60 GHz and 90 GHz for i) a radar transmissive section of a physical object, and ii) a plurality of arrangements of one or more calibration layers applied about the radar transmissive section, wherein the radar transmission section comprises a substrate and one or more coating layers applied thereto, and each calibration layer has a permittivity value that is the same. The method can also include generating a plurality predicted transmission loss values from a plurality of trial variables in the form of permittivity values and thickness values, the predicted transmission loss values corresponding to i) a hypothetical section stack, and to ii) the hypothetical section stack combined with each of the arrangements of one or more calibration layers, wherein the hypothetical section stack comprises a plurality of hypothetical coating layers applied to a hypothetical substrate of a hypothetical transmissive section of a hypothetical object. In addition, the method can include adjusting one or more of the trial variables to create a calculated radar transmission loss value at the measured frequency for i) the hypothetical section stack, and ii) a combination of each arrangement of one or more calibration layers and the hypothetical section stack, wherein the calculated versus received radar transmission loss values are within a root mean square error of less than 0.1 dB. Furthermore, the method can include, using the adjusted trial variables, performing a computational optimization routine via the computer system to predict a property of a radar correcting layer, such that the predicted radar correcting layer, when added to the hypothetical section stack, reduces the predicted radar transmission loss to meet a radar compliance requirement. Still further, the method can include providing an output of the predicted radar correcting layer to an end-user.

Additional features and advantages will be set forth in the description which follows, and in part will be obvious from the description, or may be learned by practice. The features and advantages may be realized and obtained by means of the instruments and combinations particularly pointed out in the appended claims and aspects. These and other features will become more fully apparent from the following description and appended claims, or may be learned by the practice of the examples as set forth hereinafter.

### BRIEF DESCRIPTION OF THE DRAWINGS

In order to describe the manner in which the above recited and other advantages and features can be obtained, a more particular description briefly described above will be rendered by reference to specific examples thereof, which are illustrated in the appended drawings. Understanding that these drawings are merely illustrative and are not therefore to be considered to be limiting of its scope, the present disclosure will be described and explained with additional specificity and detail through the use of the accompanying drawings in which:

FIGS. 1A-1B illustrate an environment in which a user receives a vehicle to be coated, and scans the vehicle to identify a replacement coating, in accordance with the present disclosure;

FIG. 2A illustrates a graphical illustration of a potential alignment for measuring radar transmission loss values in a coated vehicle in accordance with the present disclosure;

FIG. 2B illustrates a more detailed schematic of the alignment shown in FIG. 2A, showing a cross-section of layers in a section stack that may be measured for radar transmission loss values in accordance with the present disclosure;

FIG. 3 illustrates a graphical representation of a curve corresponding to measured radar transmission loss over frequency in accordance with the present disclosure;

FIG. 4 illustrates a block diagram of a system for modeling measured radar transmission loss data using a hypothetical coating stack and predicted signal transmission loss in accordance with the present disclosure;

FIG. 5 illustrates graphical representations of measured radar transmission loss values compared with simulated radar transmission loss values of a matching hypothetical stack in accordance with the present disclosure;

FIG. 6 illustrates a block diagram of a system for modeling a radar correcting layer predicted to minimize the predicted radar transmission loss identified in FIG. 4, in accordance with the present disclosure;

FIG. 7 illustrates a graph of simulated radar transmission loss values for an object substrate, hypothetical coating stack, and a radar correcting layer, in accordance with the present disclosure;

FIG. 8 illustrates a block diagram that measures radar transmission loss values with one or more calibration layers applied to a radar transmissive section in accordance with the present disclosure;

FIG. 9 illustrates a graphical representation that shows measured radar transmission loss values over a range of thicknesses of calibration layers in accordance with the present disclosure;

FIG. 10 illustrates a block diagram of a simulation system that determines a hypothetical coating stack using data obtained from the system of FIG. 8, in accordance with the present disclosure;

FIG. 11 illustrates a block diagram of a simulation system that finds desired radar correcting layers to meet a radar compliance requirement for the hypothetical stack determined in FIG. 10, in accordance with the present disclosure;

FIG. 12 illustrates a graphical representation of simulated radar transmission loss values with application of the determined radar correcting layer, in accordance with the present disclosure;

FIG. 13 illustrates a flowchart of a method for modeling a radar correcting layer to meet a radar compliance requirement in accordance with the present disclosure; and

FIG. 14 illustrates a flowchart of an additional or alternative method for modeling a radar correcting layer to meet a radar compliance requirement in accordance with the present disclosure.

### DETAILED DESCRIPTION

The present disclosure provides systems, methods, and computer program products for modeling radar correcting layers that enable a newly coated object to meet a radar compliance requirement. For example, a user desiring to coat an object can perform various modeling techniques to identify various transmission loss characteristics of a substrate (e.g., a transmissive section of an object). The user can also model various hypothetical coating stacks to ascertain an expected coating arrangement about the object, to predict a signal transmission loss through the hypothetical coating stacks and transmissive section of the object. The user can further model various radar correcting layers that are likely to minimize the predicted signal transmission loss.

As a preliminary matter, the definite articles “a” or “an” as used herein will be understood to mean “at least one” or “one or more” wherever occurring, unless expressly defined to mean only the singular form. In addition, by way of further explanation, the terms “module” or “component,” when used in the context of a computer system, computer-implemented methods, or corresponding structure and functions, will be understood as abstractions of generalized computer processing components that can be used in at least one implementation of the present disclosure, and there may be more or fewer than those illustrated and described, and as may be suited for a particular server and cloud operating environment. As used herein, a “module” means computer executable code that, when executed by one or more processors at a particular computer system, causing the particular computer system to perform a particular function. By contrast, a “component” means a passive set of instructions or data structures or records that can store, manage, and/or otherwise provide information handled through a particular module. One of skill in the art, however, will appreciate that the distinction between a different modules or components is at least in part arbitrary, and that modules or components may be otherwise combined and divided and still remain within the scope of the present disclosure. As such, the description of a component as being a “module” or a “component” is provided only for the sake of clarity and explanation and should not be interpreted to indicate that any particular structure of computer executable code and/or computer hardware is required, unless expressly stated otherwise. In this description, the terms “component,” “agent,” “manager,” “service,” “engine,” “virtual machine” or the like may also similarly be used.

As used herein, a “coating stack” means one or more coating or paint layers, such as any of one or more primer layers, one or more base coat layers, and/or one or more topcoat layers, or combinations thereof, including if necessary one or multiple applications of each such layer. In other words, a “coating stack” may include one basecoat layer, or one primer layer, or one primer layer and one or multiple basecoat layers, and/or topcoat layers, and/or other variants and combinations thereof. By contrast, a “section stack” means a substrate (e.g., a bumper, side panel, mirror housing, etc.) combined with a coating stack (e.g., any one or more of the previously noted layers).

As further used herein, the term “Given Section Stack” (or “given stack”) refers to “given,” values, meaning measured (in the case of an actual object), or designated, proposed, or assumed values (rather than measured or calculated values) for a proposed comparison set, which are based on known ranges for a given material or element. See, for example, Table 1. The given values represent real world values (e.g., whether measured, or entered as expected values when performing comparison tests) against which a hypothetical section stack's predicted radar transmission loss based on calculated trial variables can be compared. In other words, a “given” section stack is essentially basis comparison values, meaning actually measured values for an actual vehicle, or, in the case of a simulated real world object, chosen, proposed, or designated values within known ranges that are or may be encountered in the real world. By contrast, “hypothetical” for purposes of this disclosure comprises one or more calculated values compared against the “given.” Understandably, a “Given Section Stack” based on manually entered or “proposed” values to simulate a real-world object rather than actually measured values may also be referred to loosely as a “hypothetical section stack” where hypothetical is synonymous with the term simulated. Either way, “given” is meant to refer something an object/system that is either real, or a simulation of something that is real, or likely to be encountered in a real-world scenario.

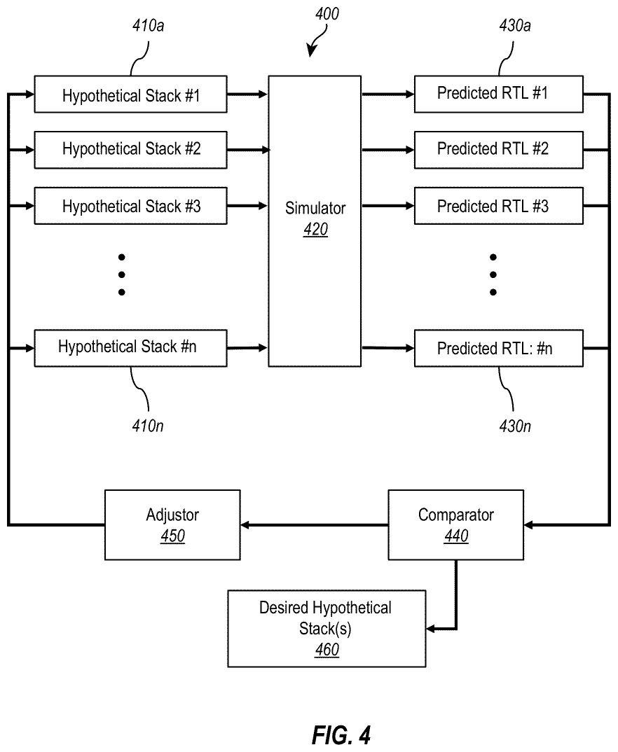

By contrast, a “hypothetical coating stack” means in at least one example a collection of thickness and permittivity values of one or more coating layers computed by the system (e.g., 400, FIG. 4) that are calculated for a coating as applied to an object. Along similar lines, a “hypothetical transmissive section,” “hypothetical radar transmissive section,” or “hypothetical section stack” means a set of thickness and permittivity values calculated for a combination of the hypothetical object substrate and the hypothetical coating stack. The values for each layer in a hypothetical coating stack or hypothetical section stack could be manually designated (as described for some “given” cases), however, the present disclosure proposes automatically generating such values in iterative operations to generate as many hypothetical stacks as possible to find at least one hypothetical section stack that results in a corresponding radar transmission curve that most closely fits the actual or real-world data (of a “Given section stack.”).

Furthermore, a “radar correcting layer” generally is used interchangeably herein with “backer layer” to mean a layer (generally a polymeric film of a particular permittivity and thickness) that is applied for long-term (or permanent basis) to the back of a radar transmissive section of an object, i.e., between the signal (e.g., radar) transceiver and the vehicle panel. Alternatively, a “calibration layer,” or “front calibration layer” is a similarly composed material that is generally applied to a front portion of a transmissive section of a vehicle, i.e., on the outside thereof. The calibration layer is typically applied only on a temporary basis for measuring certain types of signal transmission loss for purposes of characterizing the underlying substrate layer and coating stack layers at different thicknesses of calibration layer. One will appreciate, however, that both the calibration layer and radar correcting layer may be applied on a permanent or temporary basis, as needed.

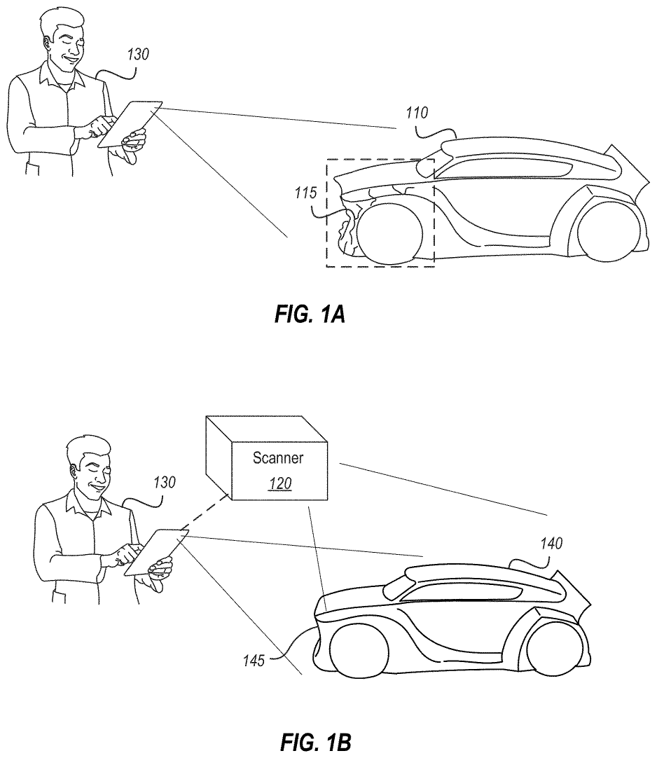

FIG. 1A illustrates one example situation in which an end user, such as an engineer/manager/mechanic 130 (hereinafter “mechanic”) receives an object (or vehicle in this case) that needs a new coating. In the illustrated case, the object is a damaged vehicle 110 with one or more damaged sections 115. One will appreciate, however, that vehicle damage is one of many reasons why an object may need to be coated, or re-coated. For example, the vehicle may need a different color of coating on the vehicle or part of the vehicle, or may need an added feature of an added coating on the vehicle or part of the vehicle. In either case, at some point the end user will need to identify a particular coating to apply. Except in cases where a user desires to coat the object with a new color, or other form of new coating, a common case involves the user using some analysis (e.g., spectrophotometric, or other color comparisons) to identify an original coating color, coating type, and other information that may be relevant (e.g., texture effects, desired clearcoat appearance). For example, FIG. 1B shows that the end user uses a scanner 120, such as a spectrophotometer to determine previously applied coating data from the object.

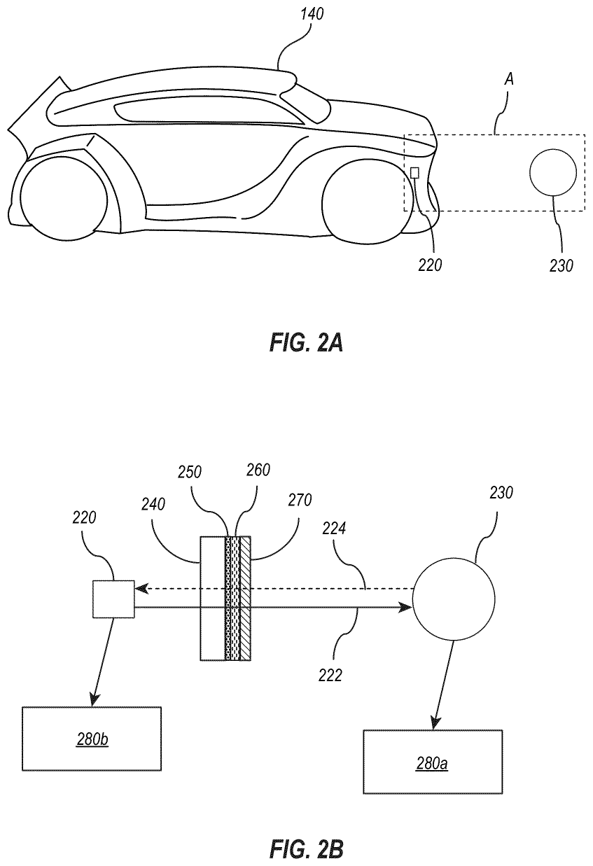

In cases of damage (e.g., a bumper, fender, door, sensors, hood, etc.) or other form of coating degradation, the user may need to first replace the damaged part (e.g., the damaged bumper of auto 140, FIG. 1A), and then coat the repaired vehicle 140 and/or replaced part (e.g., FIG. 2A) with an applicable coating determined from the original scan data. Upon application of the desired coating, the user will need to determine the effect on radar transmission loss (or “RTL”) for any signal generating elements within the vehicle (e.g., a radar transmissive section).

FIGS. 2A and 2B illustrate an example environment for measuring radar transmission loss values after repairing the damaged section or replacing and coating a part of the vehicle 140. In particular, FIGS. 2A and 2B show use of a “setting A,” namely a setting in which a signal transmitter 220 (i.e., radar transmitter or radar emitter) is positioned behind a bumper, and the user implements a receiver 230 on the outside of the bumper. One will appreciate, however, that this environment is merely exemplary, and the location of the radar transmitter 220 and receiver 230 may be in any location considered within or outside of the vehicle 140. In addition, elements 220 and 230 may alternatively be referred to as emitters and detectors, respectively. In still further or alternative configurations, elements 220 and 230 may comprise a transceiver and reflector, respectively, where the transceiver both transmits and receives the radar signal, and the reflector reflects the signal back to the transceiver. As understood throughout this specification in claims, the particular device used to transmit or receive/reflect signals can comprise any number of devices, or different combinations or alternatives thereof, so long as a signal loss is able to be determined through a given transmissive section of an object (e.g., 140).

With further reference to FIGS. 2A and 2B, one will appreciate that this environment is merely exemplary, and the location of the radar transmitter 220 and receiver 230 may be in any location considered within or outside of the vehicle 140. In addition, elements 220 and 230 may alternatively be referred to as emitters and detectors, respectively. In still further or alternative figurations, elements 220 and 230 may comprise a transceiver and reflector, respectively, where the transceiver both transmits and receives the radar signal, and the reflector reflects the signal back to the transceiver. As understood throughout this specification in claims, the particular device used to transmit or receive/reflect can comprise any number of devices, or different combinations or alternatives thereof, so long as a signal loss is able to be determined through a given transmissive section of an object (e.g., 140).

Along these lines, FIG. 2B further shows an expanded, schematic view of setting “A” with added details of the radar transmissive section of the vehicle 140 in FIG. 2B. In particular, FIG. 2B shows that the radar transmissive section of the example vehicle 140 can include several layers in cross-section, typically a substrate 240, and an applied coating stack of one or more layers (in this case, the illustrated coating layers 250, 260, 270). The material of substrate 240 can comprise any number of materials with different signal permittivity, such as plastic, rubber or composites thereof. (Parts containing metal will typically have the greatest signal loss, but may also be considered). Further, the thickness and/or permittivity of the substrate 240 may differ by vehicle. Still further, the thickness and permittivity of the substrate 240 may be different from the original thickness and permittivity after the repair. Thus, the change in thickness and permittivity of each layer after the repair results in a need to determine an appropriate radar correcting layer that can minimize attendant signal loss.

In addition to vehicle/object substrate thickness and permittivity data, the coating stack may include an adhesion promoter and sealer or primer layer (collectively, “primer layer”) 250, a basecoat 260, and a clearcoat 270. Other coating layers may also be possible, but are not shown, for simplicity. In the more common case, the coating stack can include a portion of the primer layer 250, the basecoat 260, and the clearcoat 270, or include additional coating layers. Each of the primer layer 250, the basecoat 260, and the clearcoat 270 may have a thickness that is the same or different from each other. Additionally, the permittivity of each layer in the coating stack may differ along with the thickness.

Since the applied coating layers can comprise a wide range of different components of different permittivities, and the final applied coatings may be formulated as a unique mixture to provide a given color or effect, the actual permittivity of each layer may not be known prior to application. Even if the permittivity of each layer is known, when applying each layer of the coating stack, the thickness of each layer may not be uniform or may be different from the planned thickness. Thus, even if the coating layer types and thicknesses of all layers in the coating stack have been planned or predetermined, the actual application of each layer in the applied coating stack can have significant attendant effects on transmission loss. Such fluctuations during the actual application also add difficulties in selecting an appropriate or proper radar correcting layer (or “backer layer”).

Accordingly, and as will be understood more fully herein from the present specification and claims, the present disclosure can include using a combination of measurement and simulation to identify a closest matching hypothetical section stack having a set of certain values that results in a predicted radar transmission losses that closely match the previously measured radar transmission loss values of the repaired vehicle 140. Similarly, simulations may be further performed to find one or more desired, optimal, predicted radar correcting layers, which, when applied to the combinations of the hypothetical substrate and the hypothetical coating stack, the radar transmission loss values can be minimized or made less than a threshold value (e.g., less than 5 dB, 3 dB, 2 dB, or 1 dB) for the radar compliance requirement. Based on these simulations, one or more desired or optimal correcting layers may be predicted or suggested to the end user. Details of these will be described below.

As illustrated in FIG. 2B, measurements of radar transmission loss values can be performed mono-directionally or bi-directionally. For the mono-directional measurements, the radar receiver 230 can be positioned at a predetermined distance from the radar transmitter 220. References 280a and 280b refer to a computer storage device/storage medium for storing the measurements or a computing device performing analysis on the measurements, and any related components or modules used for processing and storing the same. For the bi-directional measurements, receiver 230 can comprise a sensor or reflector, which can reflect the signal transmitted along the direction 222 by the radar transmitter 220, and the reflected signal goes back along the direction 224 to the radar transmitter 220. Reference numeral 280b may be a storage device storing the measurements or a computing device performing analysis on the measurements. For the purpose of brevity, only the monodirectional measurements are described below. However, such can be applied to the bi-directional measurements to persons having skill in the art.

The illustrated radar transmitter 220 may transmit radar signals having a range of frequencies from 1 GHz and 300 GHz, such as 60 GHz to 90 GHz, 76 GHz to 81 GHz, or even 76.5 GHz or 79 GHz. The radar transmission loss values can be measured in dB scale. In other words, the power P₀ that the radar receiver 230 receives when the radar transmits only through air (without any vehicle part between the transmitter and the receiver) is compared with a received power P₁ that the radar receiver 230 receives when a part is inserted between the transmitter and the receiver. Often, the radar transmission values are expressed in negative values in dB to indicate that a loss has occurred in transmission. In this disclosure, however, positive values in dB are used to represent the radar transmission loss values directly as an amount of loss according to the following equation:

$$Radar transmission loss value in dB = 10 \cdot {log}_{10} ( \frac{{P}_{0}}{{P}_{1}} ) .$$

Thus, a radar transmission loss of 3 dB in this disclosure may represent a radar transmission value of −3 expressed in dB. In other words, a radar transmission loss of 3 dB represents that the received power P₁, when measuring the transmission section of the vehicle, is about half of the power P₀ when measuring air-only between the radar transmitter and receiver.

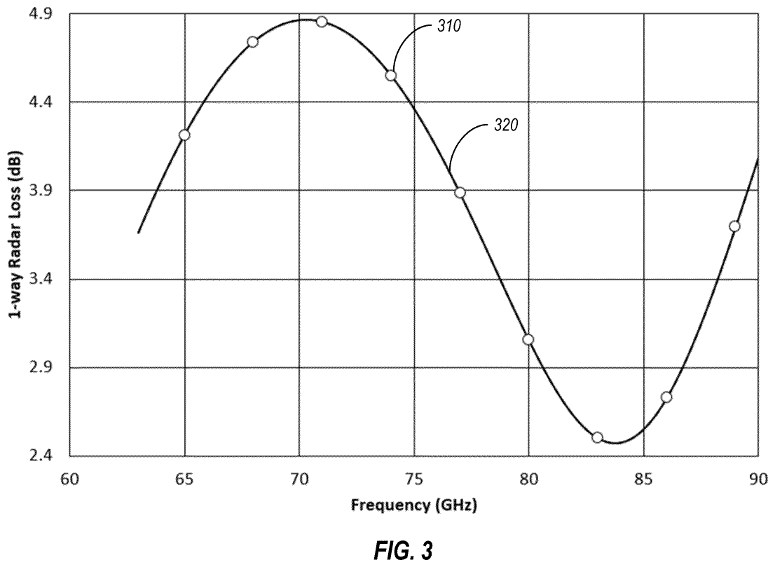

FIG. 3 illustrates a plot of measured radar transmission loss data (i.e., the replacement component of vehicle 140) at different frequency points for a Given section stack (e.g., a bumper with applied coating layer(s)). Specifically, FIG. 3 shows that the vertical axis is the mono-directional or one-way radar transmission loss values in dB scale, or in absolute values of the radar transmission values. The illustrated radar transmission loss curve 320, therefore, is generated by taking the measurement data 310 that plots in an approximately sinusoidal pattern over several frequencies, and is then smoothed out via one or more regression methods (e.g., curve-fitting).

The measured radar loss data taken by the radar receiver 230 may be measured at every 1 GHZ, 0.5 GHZ, 0.2 GHz, 0.1 GHz along a particular frequency range, such as along 1-300 GHz, including 60-100 GHz, or any other frequency interval suitable for finding a desired or optimal correcting layer. FIG. 3 shows an example of measurements from 65 GHz to 89 GHz where 3 GHz is the frequency interval. In other words, FIG. 3 shows a plot of illustrated measurements taken at 65, 68, 71, 74, 77, 80, 83, 86, and 89 GHz. In additional or alternative examples, the frequency interval for the measurement may be less than 3 GHz or 0.1 GHz and only representative measurement data 310 at 3 GHz intervals.

FIG. 3 further illustrates that the radar transmission loss value at 77 GHz is about 3.9 dB, meaning that the received power P₁ is about 41% of the original power P₀, and the radar transmission loss value at 83 GHz is about 2.5 dB. Relative to the other plot points, and consistent with the shape of curve 320, the measurement at 83 GHz appears to be the minimum transmission loss, wherein the received power P₁ is about 56% of the original power P₀. The minimum standard of acceptable radar transmission loss for purposes of this discussion may be set arbitrarily at a given threshold, such as 1.5, although an operator may use higher or lower thresholds, as noted above. With respect to FIG. 3, since the radar transmission loss values are greater than a standard set at 1.5 dB (when the received power P₁ is about 71% of the original power P₀), and the lowest value plotted is above 2.4, it might be understood that the radar system for the vehicle 140 has too high of a radar transmission loss during operation at any given frequency, and thus is unlikely to perform at full capacity. Thus, a radar correcting layer (or “backer layer”) may be necessary to reduce or potentially minimize the radar transmission loss values, and bring the radar transmission loss (RTL) for vehicle 220 to a value under 1.5 dB.

Accordingly, since the exact thicknesses and permittivity values of the repaired components of vehicle 140 (FIG. 2A) may not be known, aspects of the present disclosure enable creation of a number of different hypothetical section stacks that can be used to generate similar radar transmission loss (RTL) points over different frequencies, to thereby create simulated radar transmission loss curves, or simulated RTL curves for each particular hypothetical section stack. The simulated RTL curve of each hypothetical section stack can then be compared for best fit against the shape of the curve shown for the repaired portion of vehicle 140 (FIG. 2A), such as the measured curve shown in FIG. 3.

By way of further explanation, and as also noted above, the combination of the actual substrate layer and the actual coating layers is not typically needed, particularly given that the analysis generally applies to new coatings for which thickness and permittivity values of each layer may not be known. Instead, the present disclosure provides combinations of simulated hypothetical substrate layers and hypothetical coating stacks (together a “hypothetical section stack.”) The present disclosure further uses these hypothetical section stacks to predict a corresponding radar transmission loss value and curve for each hypothetical section stack, which can be compared against a given, such as an actual curve measured for repaired vehicle 140. To do so, the present disclosure proposes a match of data points that are close enough within an appropriate threshold, such as to an RSME of less than 0.1 dB, such as less than 0.03 dB to the measurement data 310 of the repaired vehicle 140. The predicted radar transmission loss of a hypothetical stack against which the actual values (FIG. 3) are compared, may be calculated from the permittivity and thickness of each of the layers using the transfer matrix method (TMM) which calculates the electromagnetic plane-wave reflection and transmission characteristics of stratified media as described in various references, such as The Transfer—Matrix Method in Electromagnetics, T. G. Mackay and A. Lakhtakia, Principles of Optics, 7^{th} (expanded) edition, M. Born and E. Wolf, Section 1.6, Handbook of Optics, Chapter 42, “Optical Properties of Films and Coatings”, J. A. Dobrowolski, and S. J. Byrnes, “Multilayer Optical Calculations,” the entire content of which is incorporated herein by reference.

Along these lines, FIG. 4 shows a block diagram of a simulation system 400 that performs simulations on variously generated hypothetical stacks 410a-410n generated to find a match with the radar transmission loss measured for repaired vehicle 140. The hypothetical section stacks may be created with computer-generated values within expected rages for each expected layer in a typical coating stack from which the computer system can model a radar transmission loss curve for each given hypothetical section stack. In particular, the computer system may be configured to compare the simulated radar transmission loss curve for any given hypothetical stack against a measured curve (e.g., 320, FIG. 3) of radar transmission loss for the radar transmissive section of the vehicle 140.

FIG. 4 further shows that the simulation system 400 may include a “simulator” 420, a “comparator” 440, and an “adjustor” 450. One will appreciate that these various terms refer to various computer components, modules, or processing elements that execute instructions to provide a particular result. For example, in response to various inputs understood more fully herein, the simulation system 400 may use various inputs with the adjustor 450, comparator 440, and simulator 420 to output one or more desired hypothetical stacks 460 for the radar transmissive section.

As previously noted, the illustrated hypothetical stacks 410a-410n have values and layers generated as closely as possible to represent the same (or substantially similar) stack arrangement as used in a real measurement of a vehicle substrate with applied coating layers, such as the stack shown in FIG. 2B. Where possible, the hypothetical section stack layer variables will match the actual (but unknown) variables for the actually applied coating on the given object 140. One will understand in view of the present disclosure, however, that there does not need to be 1:1 correlation between layers, layer thicknesses, or corresponding permittivity values when comparing a generated hypothetical section stack or hypothetical section stack with an actual coating stack or actual section stack. Again, in at least some cases, measuring the shape of a resulting curve of radar transmission loss values resulting from the simulation against the shape of the measured curve values will suffice. Further along these lines, the hypothetical section stack layer variables do not need to match the actual (but unknown) variables for the actually applied coating on the given object 140 in terms of thickness and permittivity. Each hypothetical layer of a hypothetical stack can include permittivity values including both a real permittivity value and an imaginary permittivity value.

For purposes of illustration, Table 1, as shown below, includes examples of thickness values, real permittivity values, and imaginary permittivity values selected or chosen for various layers of several different “Given Section Stacks,” meaning actual or real-world representations or simulations of section stacks (i.e., a portion of an object or vehicle with applied one or more coating layers). The illustrated 10 “Given Section Stacks” of Table 1 were prepared for testing purposes to provide various bases of comparison as real-world object section stacks against which a plurality of hypothetical section stacks would be compared. Thus, each Given section stack 1-10 below in Table 1 may alternatively be thought of as representing 10 different actual objects or vehicles, and corresponding measurements of a Given section stack for each vehicle, namely measurements of particular thickness and permittivity values at any particular layer in a section stack for each particular vehicle (e.g., 1-10) at its radar transmissive section.

TABLE 1

| Given | | | | | | | | | | | | |
|---|---|---|---|---|---|---|---|---|---|---|---|---|
| Section | | | | | | | | | d_{substrate} | d_{primer layer} | d_{basecoat} | d_{clearcoat} |
| Stack | ε′_{substrate} | ε″_{substrate} | ε′_{primer layer} | ε″_{primer layer} | ε′_{basecoat} | ε″_{basecoat} | ε′_{clearcoat} | ε″_{clearcoat} | (μm) | (μm) | (μm) | (μm) |
| 1 | 2.357 | 0.0080 | 4.524 | 0.092 | 37.000 | 4.000 | 2.730 | 0.020 | 2785 | 28.0 | 21.0 | 51.0 |
| 2 | 2.466 | 0.0001 | 10.000 | 0.050 | 50.000 | 1.000 | 2.700 | 0.020 | 2800 | 25.0 | 15.0 | 49.0 |
| 3 | 3.130 | 0.0001 | 9.000 | 0.050 | 30.000 | 1.000 | 2.700 | 0.020 | 3000 | 20.0 | 25.0 | 60.0 |
| 4 | 2.700 | 0.0001 | 8.000 | 0.080 | 60.000 | 3.000 | 2.700 | 0.020 | 2760 | 10.0 | 20.0 | 55.0 |
| 5 | 2.900 | 0.0009 | 5.000 | 0.050 | 65.000 | 5.000 | 2.700 | 0.020 | 2735 | 25.0 | 25.0 | 40.0 |
| 6 | 2.500 | 0.0010 | 6.500 | 0.050 | 15.000 | 1.000 | 2.700 | 0.020 | 2930 | 9.0 | 23.0 | 54.0 |
| 7 | 2.600 | 0.0010 | 10.100 | 0.050 | 12.000 | 0.500 | 2.800 | 0.020 | 2700 | 10.0 | 35.0 | 52.0 |
| 8 | 2.700 | 0.0010 | 9.900 | 0.050 | 59.000 | 4.000 | 2.750 | 0.020 | 2970 | 19.0 | 31.0 | 49.0 |
| 9 | 2.350 | 0.0010 | 8.400 | 0.050 | 51.000 | 3.000 | 2.750 | 0.020 | 3010 | 11.0 | 22.0 | 60.0 |
| 10 | 2.520 | 0.0020 | 10.500 | 0.050 | 48.000 | 2.000 | 2.750 | 0.020 | 2570 | 9.5 | 33.5 | 50.5 |

By way of explanation, ε′ represents a real permittivity, ε″ represents an imaginary permittivity, and “d” represents a thickness. Subscripts of ε′, ε″, and “d” are names of the corresponding layers. For example, ε′_{primer layer} represents the real permittivity of primer layer, and d_{basecoat} represents a thickness of the basecoat.

Referring again to FIG. 4, for a “Given Section Stack” in Table 1 (or for any vehicle received in for repair), one or more hypothetical section stacks may be created (i.e., set of stacks 410a) which have various “trial variables” of generated real and/or imaginary permittivity and thickness values at each expected layer in order to create a predicted radar transmission loss to compare against the particular Given (e.g., one of the 1-10 Givens in Table 1). A computer system can be used to iteratively generate various hypothetical section stacks with various computer-generated trial variable values for layers, such as thickness and permittivity values within acceptable ranges. The generated permittivity and thickness values can then be used by a simulator 420 to prepare a set of predicted radar transmission loss values (i.e., simulated radar transmission loss values, or “Predicted RTL”) for each hypothetical section stack at any particular frequency value in a range from 1 to 300 GHz, such as a range of from 60 GHz to 90 GHz as in FIG. 3. In general, the simulator 420 sets a simulation environment, which attempts to employ an environment that is as close as possible to the actual environmental setting in which the measured values are taken. For example, the simulator 420 may include settings for the frequency resolution of the radar receiver 230, or other mechanical issues that may need to be considered. The simulator 420 can use these settings to perform simulations with the hypothetical stacks 410a-410n, to thereby generate predicted radar transmission loss values 430a-430n, which are derived from the combination of layer values for the generated hypothetical stacks 410a-410n, respectively.

In one example, the simulator 420 may perform simulations serially, meaning that simulation of one hypothetical stack is performed first and a simulation of another hypothetical stack is performed next. Likewise, each simulation result (i.e., predicted radar transmission loss values 430a-430n) of the predicted values for each hypothetical section stack may be serially compared by the comparator 440 with the measured radar transmission loss values (e.g., the measurement data 310 of FIG. 3). Adjustments of “trial variables” (i.e., thicknesses and permittivities of each layer of a particular hypothetical section stack) by the adjustor 450 may be performed at once after all simulations and comparisons are performed, and no hypothetical stack is found to match the measurement data 310 within a threshold. In another example, the simulator 420 may, in parallel, perform the simulations, meaning that simulations of hypothetical stacks (410a-n) are parallelly performed by corresponding parallel computing modules in the simulator 420. The parallel computations may then result in essentially parallel generated, simulated radar transmission loss values 430a-430n, which in turn may be plotted to form a curve of a particular shape, similar to the plot of Given data in FIG. 3.

The comparator 440 may further compare each of the simulated radar transmission loss values 430a-430n for each hypothetical section stack with the measurement data (e.g., from a real object), such as the data points 310 in FIG. 3, if comparing against vehicle 140. Differences at each frequency may be calculated and combined to generate the total difference between each simulated radar transmission loss value with the measurement data 310. The difference may be a sum of arithmetic differences, a RMSE, a ratio, or any other mathematical measure.

For example, the comparator 440 may calculate mathematical measures. For example, L-1 error is a sum of absolute values of distances at every frequency, as calculated by the following equation (1), and L-2 error may be a root mean square error (or RMSE) as calculated by the following equation (2):

$${L}_{1} = \frac{{\sum }_{{f}_{i}}^{{f}_{N}} \vert {s}_{{f}_{i}} - {m}_{{f}_{i}} \vert}{N} , \qquad ( 1 )$$

$$and$$

$${L}_{1} = \sqrt{\frac{{\sum }_{{f}_{i}}^{{f}_{N}} {( {s}_{{f}_{i}} - {m}_{{f}_{i}} )}^{2}}{N}} , \qquad ( 2 )$$

where fᵢ represents i-th frequency, at which the measurement data 310 of FIG. 3 has been measured. In addition, s_{f}_{ᵢ} represents a predicted or simulated radar transmission loss value at fᵢ, m_{f}_{ᵢ} represents a measured radar transmission loss value at fᵢ, and N represents a number of frequencies, at which the measurement data 310 has been measured. In this disclosure, the RMSE is used for purposes of simplicity, but other mathematical measures can be used readily by persons having skill in the art to calculate the total errors between the measurement data 310 and the simulated or calculated radar transmission loss values 430a-430n.

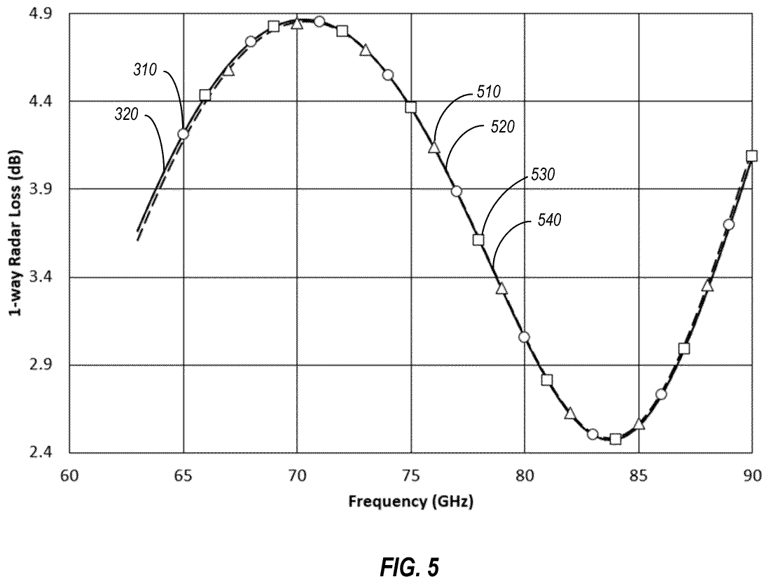

In examples where the RMSE difference in dB is less than a threshold (e.g., 1 dB or less, 0.3 dB or less, 0.1 dB, 0.03 dB, 0.01 dB, 0.001 dB, or any other suitable value in dB), the corresponding hypothetical stack may be determined to correspond to the radar transmissive section of the vehicle. This may be evident when plotting the predicted radar transmission loss points at any given frequency for the particular hypothetical section stack, and showing how the resultant curve overlaps with a curve of plot points from a Given section stack (e.g., FIG. 5).

In other cases where differences are not less than the threshold, the adjustor 450 may adjust trial variables, such as thickness, real permittivity, or imaginary permittivity of each layer for further simulations by the simulator 420. These simulations, comparisons, and adjustments of trial variables of each layer in the hypothetical stacks 410a-410n may be performed repeatedly until one or more hypothetical stacks are determined to have simulated radar transmission loss data and curves that match real measurements of the Given section stack.

Once identifying a hypothetical section stack (or stacks) that has predicted radar transmission loss values that match the measured values (e.g. FIG. 3 for vehicle 140) or any of the Given section stacks 1-10, the simulator can then model various radar correcting layers that adjust the radar transmission loss values for the matching hypothetical section stack(s), until identifying a radar correcting layer of particular thickness and/or permittivity that causes the radar transmission loss values for the matching hypothetical section stack(s) to fall to within an acceptable minimum.

Table 2 (below) shows an example of adjustments by the adjustor 450 both before and after a radar correcting layer (or backer layer, BL) has been applied to a particular hypothetical stack 410a. In particular, Table 2 shows that a radar correcting layer of particular dimensions and permittivity can be added to a particular hypothetical section stack to cause the predicted radar loss of that hypothetical section stack to drop significantly, namely to minimize the predicted radar transmission loss value of the particular hypothetical stack, such that the predicted transmission loss of that particular hypothetical section stack within a desired frequency range falls to within a particular threshold value.

TABLE 2

| | | | | | | d_{BL} (μm) |
|---|---|---|---|---|---|---|
| | | | Loss in dB at 76.5 | | | rounded to |
| Hypothetical | Loss in dB at 76.5 | Loss in dB at | GHz with BL rounded | | | nearest 100 |
| Section Stack | GHz without BL | 76.5 GHz with BL | to nearest 100 μm | ε′_{BL} | d_{BL} (μm) | μm |
| 1 | 2.78 | 0.59 | 0.59 | 4 | 493 | 500 |
| 2 | 2.83 | 0.22 | 0.24 | 4 | 421 | 400 |
| 3 | 0.51 | 0.51 | 0.51 | 3 | 12 | 0 |
| 4 | 3.60 | 0.85 | 0.87 | 4 | 320 | 300 |
| 5 | 4.02 | 1.84 | 1.87 | 4 | 220 | 200 |
| 6 | 1.42 | 0.18 | 0.19 | 3 | 475 | 500 |
| 7 | 1.67 | 0.25 | 0.25 | 2.5 | 683 | 700 |
| 8 | 3.40 | 2.67 | 2.67 | 4 | 99 | 100 |
| 9 | 3.12 | 0.93 | 1.03 | 4 | 256 | 300 |
| 10 | 5.01 | 1.28 | 1.42 | 4 | 553 | 600 |

Since it may not be practical to manufacture the radar correcting layer for any possible thickness, having radar correcting layers at incremental thickness values is recommended. The radar transmission loss values with the thickness of the radar correcting layer rounded to the nearest 100 μm at 76.5 GHz are also included in TABLE 2. These data demonstrate that it may be satisfactory to round the optimal radar correcting layer thickness to the nearest 100 μm.

Based on TABLE 2, the system 400 has determined that, for the first hypothetical section stack, and when considering a frequency of 76.5 GHZ, a radar correcting layer having a thickness of 493 μm and real permittivity of 4 can reduce the predicted radar transmission loss of that hypothetical section stack from 2.82 dB to 0.71 dB. Rounded to the nearest 100 μm, this places the proposed radar correcting layer at 500 μm. One will appreciate, however, that rounding to the nearest 100 μm is not required, and that the size of radar correcting (or backer layer) can be adjusted to the nearest 50 μm or the nearest 25 μm.

Among these hypothetical stacks, the fifth hypothetical stack without the radar correcting layer has a radar transmission loss value of 4.02 dB at 76.5 GHZ, which is similar to the measurement loss value about 3.9 dB at 77 GHz according to the curve 320 of FIG. 3. However, with the application of the radar correcting layer, which has the real permittivity of 4 and the optimized thickness of 220 μm, the radar transmission loss value at 76.5 GHz is about 1.84 dB or 1.87 dB with the thickness of the radar correcting layer rounded to the nearest hundred μm. Both 1.84 dB and 1.87 dB, however, may still not be less than a threshold, which as noted may be 3.0 dB, 2.0 dB, 1.5 dB, 1.0 dB, 0.5 dB, or less. That is, 1.84 dB and 1.87 dB are above a 1.5 dB threshold, and below a 3.0 dB threshold. To get this hypothetical section stack to have a lower transmission loss rate, therefore, a different radar correcting layer of a different permittivity and/or thickness can be evaluated in the Simulator 420 and Comparator 440.

Thus, to make the radar transmission loss values of each hypothetical section stack closer to the measurement data of a particular radar transmission loss measured of a Givenl section stack (e.g., from Table 1), the adjustor 450 may adjust trial variables of layers in each hypothetical stack until getting closely matching predicted radar transmission loss data for any Given section stack. For example, the adjustor 450 adjusts a real permittivity, an imaginary permittivity, and a thickness of the substrate, a primer layer, basecoat, and clearcoat for a particular hypothetical section stack. In one example, when certain trial variables of the hypothetical stacks have little impact on the change of the difference from the measurement data for a Given, the adjustor 450 may be provided settings that make them constant, so as to reduce the computing power required for simulations. In this regard, the adjustor 450 may force some hypothetical trial variables to be constant.

For example, TABLE 3 shows parameters (or “trial variables”) of a particular hypothetical section stack to be varied by the adjustor 450 and other parameters to be maintained constant.

TABLE 3

| | | | | | | | | | d_{substrate} | d_{primer layer} | d_{basecoat} | d_{clearcoat} |
|---|---|---|---|---|---|---|---|---|---|---|---|---|
| Condition | ε′_{substrate} | ε″_{substrate} | ε′_{primer layer} | ε″_{primer layer} | ε′_{basecoat} | ε″_{basecoat} | ε′_{clearcoat} | ε″_{clearcoat} | (μm) | (μm) | (μm) | (μm) |
| Vary | 2.5 | 0.0015 | — | — | 40 | 3 | — | — | 2850 | 15 | 15 | 45 |
| Keep | — | — | 8.2 | 0.05 | — | — | 2.73 | 0.02 | — | — | — | — |
| constant | | | | | | | | | | | | |

Based on TABLE 3, ε′_{substrate} of 2.5 means that the adjustor 450 may change the real part of the permittivity of the substrate (ε′_{substrate}) by increasing or decreasing the value of a hypothetical section stack. In addition, the adjustor 450 may keep ε′_{primer layer} and ε′_{primer layer}, the real and imaginary parts of the permittivity of the adhesion promoter and sealer or primer layer of the hypothetical section stack, to be constant. In this way, the adjustor 450 can lessen calculation loads on the simulator 420 by reducing the number of ways to create possible hypothetical section stacks.

In an additional or alternative example, the adjustor 450 may utilize a generalized reduced gradient non-linear method in adjusting the parameter values. In particular, the generalized reduced gradient non-linear method can find whether to increase or decrease each parameter value to be close to the measurement data. By increasing or decreasing each parameter value by a small amount, the adjustor 450 may be able to find an optimal combination of trial variables for each hypothetical stack.

For example, as shown below in TABLE 4, the adjustor 450 sets the real and imaginary permittivity of the basecoat and the clearcoat trial variables to be constant, and adjusts the other hypothetical section stack trial variables. After iteratively adjusting the hypothetical section stack trial variables based on the generalized reduced gradient non-linear method, the adjustor 450 is able to find optimal trial variables that result in a predicted radar transmission loss that corresponds closely to a particular “Given Section Stack” of TABLE 1. For example, this result may be determined for any particular hypothetical section stack where the various layer values are adjusted until the predicted transmission loss values of the same matches the measurement data 310 with a real or given section stack within a suitably small RMSE variation, such, 0.1 or less, including less than 0.03 dB as shown in TABLE 6.

TABLE 4 shows desired and/or optimal values of the layers in the hypothetical section stacks based on the generalized reduced gradient non-linear method. These desired hypothetical stacks 460 having the following parameter values are outputted by the comparator 440, as shown below.

TABLE 4

| Hypothetical | | | | | | | | | | | | |
|---|---|---|---|---|---|---|---|---|---|---|---|---|
| Section | | | | | | | | | d_{substrate} | d_{primer layer} | d_{basecoat} | d_{clearcoat} |
| Stack | ε′_{substrate} | ε″_{substrate} | ε′_{primer layer} | ε″_{primer layer} | ε′_{basecoat} | ε″_{basecoat} | ε′_{clearcoat} | ε″_{clearcoat} | (μm) | (μm) | (μm) | (μm) |
| 1 | 2.264 | 0.0000 | 8.200 | 0.050 | 41.463 | 4.716 | 2.730 | 0.020 | 2850 | 15.5 | 19.0 | 45.1 |
| 2 | 2.385 | 0.0001 | 8.200 | 0.050 | 42.668 | 0.000 | 2.730 | 0.020 | 2850 | 15.8 | 20.9 | 45.2 |
| 3 | 3.151 | 0.0000 | 8.200 | 0.050 | 41.695 | 1.477 | 2.730 | 0.020 | 3000 | 15.5 | 18.8 | 45.0 |
| 4 | 2.612 | 0.0000 | 8.200 | 0.050 | 58.313 | 1.068 | 2.730 | 0.020 | 2798 | 14.8 | 21.1 | 46.2 |
| 5 | 2.888 | 0.0019 | 8.200 | 0.050 | 62.763 | 4.500 | 2.730 | 0.020 | 2750 | 15.0 | 25.4 | 47.5 |
| 6 | 2.784 | 0.0163 | 8.200 | 0.050 | 36.409 | 0.000 | 2.730 | 0.020 | 2852 | 13.1 | 3.6 | 44.8 |
| 7 | 2.481 | 0.0049 | 8.200 | 0.050 | 20.149 | 0.040 | 2.730 | 0.020 | 2760 | 14.8 | 21.4 | 45.1 |
| 8 | 2.485 | 0.0000 | 8.200 | 0.050 | 65.116 | 0.000 | 2.730 | 0.020 | 3102 | 0.0 | 30.6 | 133.2 |
| 9 | 2.515 | 0.0105 | 8.200 | 0.050 | 57.298 | 4.819 | 2.730 | 0.020 | 2920 | 14.9 | 18.0 | 50.0 |
| 10 | 2.400 | 0.0000 | 8.200 | 0.050 | 64.057 | 0.352 | 2.730 | 0.020 | 2630 | 15.9 | 25.1 | 60.0 |

Another adjustment method may be applied to the hypothetical stacks 410a-410n. For example, the limited-memory Broyden-Fletcher-Goldfarb-Shanno (L-BFGS) or limited-memory Broyden-Fletcher-Goldfarb-Shanno with bound constraints (L-BFGS-B) method may be used by the adjustor 450. At each iteration, the increasing or decreasing direction can be determined for each trial variable with a corresponding bound for each trial variable according to the L-BFGS and L-BFGS-B methods. The L-BFGS-B method can additionally use a line search technique to determine a variable step size along the increasing or decreasing direction. In this case, the trial variables of the real and imaginary permittivity and thickness of the basecoat and the clearcoat are set to be constant, and the other trial variables are modulated based on the L-BFGS-B method. Based on the L-BFGS-B method, trial variables of the layers of each hypothetical stack have been optimized as shown below in TABLE 5.

TABLE 5

| Hypothetical | | | | | | | | | | | | |
|---|---|---|---|---|---|---|---|---|---|---|---|---|
| Section | | | | | | | | | d_{substrate} | d_{primer layer} | d_{basecoat} | d_{clearcoat} |
| Stack | ε′_{substrate} | ε″_{substrate} | ε′_{primer layer} | ε″_{primer layer} | ε′_{basecoat} | ε″_{basecoat} | ε′_{clearcoat} | ε″_{clearcoat} | (μm) | (μm) | (μm) | (μm) |
| 1 | 2.269 | 0.0000 | 8.200 | 0.050 | 51.934 | 6.066 | 2.730 | 0.020 | 2850 | 15.0 | 15.0 | 45.0 |
| 2 | 2.390 | 0.0000 | 8.200 | 0.050 | 58.816 | 0.003 | 2.730 | 0.020 | 2850 | 15.0 | 15.0 | 45.0 |
| 3 | 3.572 | 0.0000 | 8.200 | 0.050 | 45.008 | 3.491 | 2.730 | 0.020 | 2850 | 15.0 | 15.0 | 45.0 |
| 4 | 2.521 | 0.0000 | 8.200 | 0.050 | 82.622 | 0.000 | 2.730 | 0.020 | 2850 | 15.0 | 15.0 | 45.0 |
| 5 | 2.684 | 0.0000 | 8.200 | 0.050 | 111.307 | 0.000 | 2.730 | 0.020 | 2850 | 15.0 | 15.0 | 45.0 |
| 6 | 2.714 | 0.0000 | 8.200 | 0.050 | 13.525 | 2.159 | 2.730 | 0.020 | 2850 | 15.0 | 15.0 | 45.0 |
| 7 | 2.491 | 0.0000 | 8.200 | 0.050 | 17.458 | 0.513 | 2.730 | 0.020 | 2750 | 15.0 | 25.0 | 45.0 |
| 8 | 2.973 | 0.0037 | 8.200 | 0.050 | 112.674 | 17.269 | 2.730 | 0.020 | 2850 | 15.0 | 15.0 | 45.0 |
| 9 | 2.661 | 0.0187 | 8.200 | 0.050 | 64.835 | 6.533 | 2.730 | 0.020 | 2850 | 15.0 | 15.0 | 45.0 |
| 10 | 2.468 | 0.0000 | 8.200 | 0.050 | 79.057 | 2.576 | 2.730 | 0.020 | 2600 | 15.0 | 20.0 | 45.0 |

The results of these two methods (the generalized reduced gradient non-linear method and the L-BFGS-B method) are illustrated in FIG. 5.

In particular, FIG. 5 shows various data plots of both real and simulated data overlayed on top of each other. For example, the data 510 comprise predicted radar transmission loss values for a particular hypothetical section stack generated through simulator 420. In the illustrated case, data plot 310 represents actual measurement data for a transmissive section of an object (e.g., vehicle 140, with sections 240, 250, 260, 270). Curve 320, in turn, is a visual representation of the data plot 310 as a solid smooth curve. Likewise, data plots 510 and 530 are simulated radar transmission loss values based on the two methods (e.g., the generalized reduced gradient non-linear method and the L-BFGS-B method), and curves 520 and 540 are a short-dash curve and a long-dash curve, respectively, which fit the data plot 310 of measured loss values based on the two methods. Curve 520 (short-dash curve) is not visible in FIG. 5, because the fit is so close to that of the solid-line curve 320. These two methods for the adjustor 450 are provided as examples and other adjustment methods may also be used for the adjustor 450.

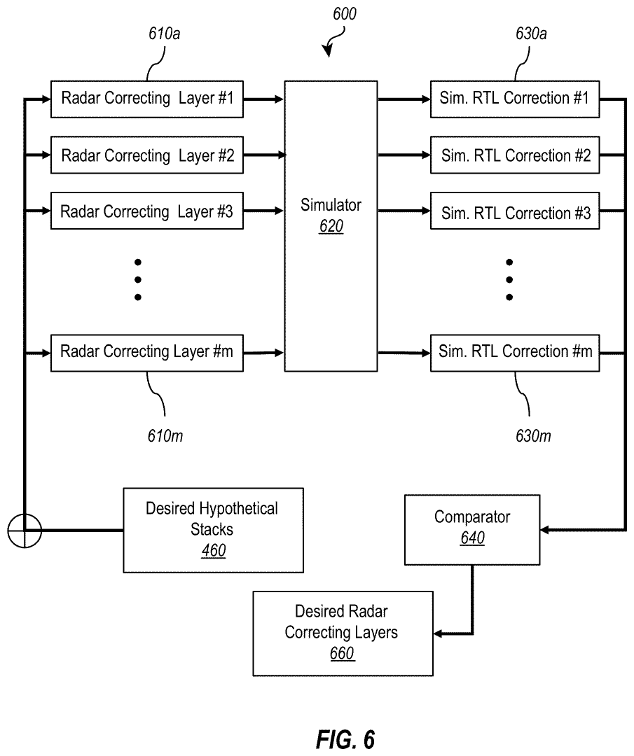

Accordingly, the hypothetical section stack that generated the predicted radar transmission loss values 510, and 530 is determined to be a sufficiently close analog in this case to the Given section stack modeled and plotted out in FIG. 3. Accordingly, a radar correcting layer that adjusts the hypothetical section stack that generated values 510, 530, etc. would be understood as applicable to that Given section stack corresponding to FIG. 3. Thus, the user can further use the simulator system described herein to find a suitable radar correcting layer that can improve expected radar transmission loss for the matching hypothetical section stack, and hence the Given section stack. This can be done, for example, by using the simulation system 600 illustrated in FIG. 6. By way of explanation, each of the simulation, adjustor, and comparator components described herein may be the same or different sets of components deployed in one or more computing systems. Accordingly, the separate numbering used herein for each component is by way of convenience for illustrating the given simulator, adjustor, or comparator, as the case may be, in a particular context.

FIG. 6 shows an example in which the computing system simulates use of the desired, hypothetical radar correcting layers 610a-610m added to each identified hypothetical stack 460 along with the resulting radar transmission loss. In general, each of the proposed radar correcting layers 610a-610m may have a different thickness (and/or permittivity) from each other, thus providing different, simulated transmission loss values 630a. Further, each radar correcting layer may be a combination of two or more radar correcting layers with same or different thickness and/or permittivity for different transmission loss effects.

FIG. 6 further shows the results from the simulator 620, i.e., simulated radar transmission loss values 630a 630m. A comparator 640 may in turn compare the simulated radar transmission loss values 630a 630m with a threshold value based on the radar compliance requirement. The comparator 640 may then determine which radar correcting layer is optimal, or output one or more desired radar correcting layers 660 when the radar correcting layer brings the predicted radar transmission loss below an acceptable threshold value (e.g., 5.0 dB or lower, such as 3.0 dB, 2.0 dB, 1.5 dB, 1.0 dB, 0.5 dB, or less). In other words, if a given radar correcting layer that has been simulated with the matching hypothetical section stack and produces an acceptable radar transmission loss in the right frequency range for that hypothetical section stack, then the radar correcting layer (or set of layers) can be recommended to the user for use with the relevant Given section stack to which the hypothetical section stack is deemed a good match.

This simulation can be performed for any particular Given section stack (Table 1) until an acceptable hypothetical section stack and appropriate radar correcting layer(s) have been determined for making the particular Given section stack compliant with a radar transmission loss requirement. In a case where two or more potential radar correcting layers provide the simulated radar transmission loss values less than the threshold value, a desired radar correcting layer 660, which provides the lowest (or best) simulated radar transmission loss value, may be outputted by the comparator 640 so that only one optimal radar correcting layer is outputted for each desired hypothetical stack 460. Alternatively, the comparator 640 may output a list of multiple radar correcting layers, which make the combination of the desired hypothetical stacks 460 with the radar correcting layers radar compliant. An end-user may select one or more of the one or more displayed radar correcting layers, and then apply the selected radar correcting layer(s) where appropriate on the object (e.g., the back of the radar transmissive section of the vehicle).

Table 6 shows the application of radar correcting layers to a particular hypothetical section stack from TABLE 4, wherein the radar correcting layers have been obtained based on the generalized reduced gradient non-linear method. Table 6 also illustrates the thickness (dBL) for each of the radar correcting layers, or backer layers (i.e., “BL”), with given permittivity (¿′BL), outputted by the comparator 640 for each hypothetical section stack from TABLE 4. Table 6 further shows that comparison of hypothetical section stack RTL values measured against the Given section stack to which it was compared. Table 6 shows that in this case the hypothetical section stacks all had an RMSE value less than 0.03 dB in comparison to the Given section stack with which it was compared.

TABLE 6

| | | | | | | Loss | |
|---|---|---|---|---|---|---|---|
| | | | | | | (dB)@ | |
| | | | | | | 76.5 | |
| | | | | | | GHz | |
| | | | | Radar | | [with | |
| | | | | Loss | | BL | |
| | Radar | | | (dB)@ | d_{BL} (μm) | round | RMSE (dB) |
| | Loss | | | 76.5 | Rounded | to | Given |
| | (dB)@ | | | GHz | to | nearest | Compared |
| Hypothetical | 76.5 GHz | | d_{BL} | [with | Nearest | 100 | with |
| Stack | [No BL] | ε′_{BL} | (μm) | BL] | 100 μm | μm] | Hypothetical |
| 1 | 2.78 | 4 | 490 | 0.59 | 500 | 0.59 | 0.0015 |
| 2 | 2.82 | 4 | 416 | 0.14 | 400 | 0.15 | 0.0089 |
| 3 | 0.51 | 3 | 12 | 0.51 | 0 | 0.51 | 0.0019 |
| 4 | 3.60 | 4 | 316 | 0.74 | 300 | 0.75 | 0.0048 |
| 5 | 4.02 | 4 | 220 | 1.83 | 200 | 1.86 | 0.0002 |
| 6 | 1.42 | 3 | 490 | 0.23 | 500 | 0.23 | 0.0031 |
| 7 | 1.66 | 2.5 | 681 | 0.22 | 700 | 0.22 | 0.0036 |
| 8 | 3.41 | 4 | 94 | 2.68 | 100 | 2.68 | 0.0245 |
| 9 | 3.12 | 4 | 262 | 1.09 | 300 | 1.15 | 0.0005 |
| 10 | 5.01 | 4 | 550 | 1.08 | 600 | 1.24 | 0.0056 |

Table 6 further shows that the system 600 determined thickness values for an appropriate radar correcting (or backer) layer using one, assumed permittivity value (e.g., 2.5, 3, or 4). Nevertheless, one of ordinary skill in the art will appreciate that the simulation system 600 could be provided with a set of possible permittivity values for the radar correcting layer for a given hypothetical stack, and the thickness could be optimized for each, and the radar 10 correcting layer with the lowest radar transmission loss could be chosen. Alternatively, the simulation system 600 could determine both the optimal permittivity and thickness for the radar correcting layer, and while this is computationally and theoretically feasible, this may not also be practical since an end user may not have appropriate means to adjust permittivity of radar correcting material composition. More commonly, therefore, the simulators 420, 620 could hold permittivity constant (e.g., suggested or known values for each proposed layer material in the stack), and allow thickness to adjust.

In the case that the RMSE for the radar transmission loss curves of the hypothetical stacks in Table 6 compared to the those of the Given section stacks in Table 1 are less than or equal to 0.03 dB, all of the hypothetical stacks provide acceptably good matches to the radar transmission loss curves of the original, Given section stacks shown in Table 1. Table 6 also shows that all of the hypothetical stacks (except for #8) provide very good matches with RMSE values less than 0.01 dB. Further, 7 of these 10 hypothetical stacks (all except #2, #8, and #10) provide exceptionally good matches with RMSE values less than 0.005 dB. The small RMSE values in Table 6 and the resulting very close values of the predicted radar correcting layer thicknesses in Table 6 compared the of Table 2, and finally, the exact values of the radar correcting layers rounded to the nearest 100 μm in Table 6 compared to those of Table 2, demonstrate that a proper radar correcting layer for a Given section stack can be predicted by the method of creating a hypothetical stack that provides a predicted radar transmission loss at various frequences that in turn match those measured for an original, Given section stack.

Consistent with the foregoing, the difference in radar transmission loss values between a Given section stack and the matched hypothetical section stack are shown below in Table 7. The values of Table 7 were generated by employing the L-BFGS-B with the desired hypothetical stacks in TABLE 5 (e.g., simulated by the simulation system 600), with resulting RMSE and corresponding thickness and permittivity values for the radar correcting layer (or Backer Layer-“BL”), and results thereof, shown in Table 7 below.

TABLE 7

| | | | | | | Loss | |
|---|---|---|---|---|---|---|---|
| | | | | | | (dB)@ | |
| | | | | | | 76.5 | |
| | | | | | | GHz | |
| | | | | Loss | | [with | |
| | | | | (dB)@ | d_{BL} (μm) | BL | RMSE (dB) |
| | Loss | | | 76.5 | rounded | round | Given |
| | (dB)@ | | | GHz | to | to | Compared |
| Hypothetical | 76.5 GHz | | d_{BL} | [with | nearest | nearest | with |
| Stack | [No BL] | ε′_{BL} | (μm) | BL] | 100 μm | 100 μm] | Hypothetical |
| 1 | 2.78 | 4 | 490 | 0.59 | 500 | 0.59 | 0.0014 |
| 2 | 2.82 | 4 | 416 | 0.14 | 400 | 0.15 | 0.0069 |
| 3 | 0.49 | 3 | 800 | 0.49 | 0 | 0.49 | 0.0295 |
| 4 | 3.58 | 4 | 312 | 0.67 | 300 | 0.68 | 0.0241 |
| 5 | 4.02 | 4 | 215 | 1.65 | 200 | 1.67 | 0.0230 |
| 6 | 1.42 | 3 | 487 | 0.23 | 500 | 0.23 | 0.0012 |
| 7 | 1.66 | 2.5 | 681 | 0.22 | 700 | 0.22 | 0.0027 |
| 8 | 3.40 | 4 | 103 | 2.73 | 100 | 2.73 | 0.0009 |
| 9 | 3.12 | 4 | 267 | 1.19 | 300 | 1.24 | 0.0010 |
| 10 | 5.01 | 4 | 550 | 1.20 | 600 | 1.36 | 0.0028 |

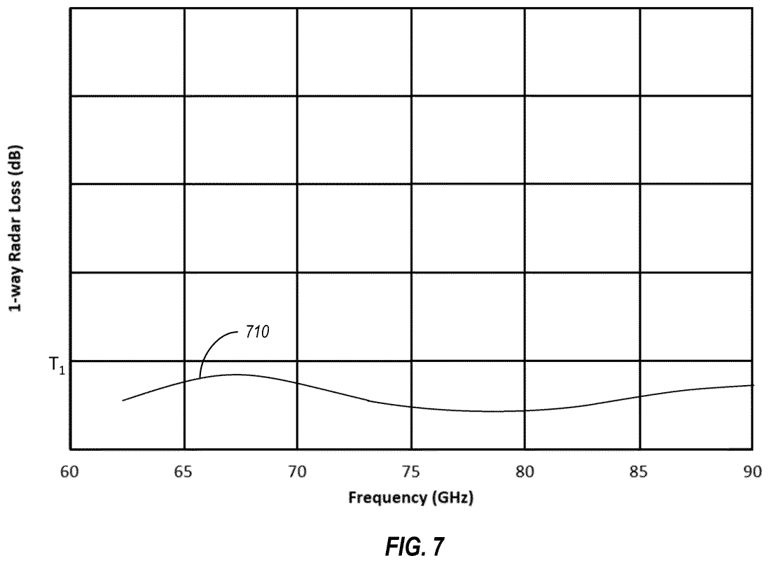

FIG. 7 illustrates the resultant curve 710 of radar transmission loss over frequency based on a desired hypothetical section stack that has been combined with an optimized radar correcting layer, or backer layer (“BL”). In particular, after application of a desired radar correcting layer, which has been found based on the simulation system 600, the 1-way radar loss curve 710 is below the threshold value T₁ over the range of frequencies. Using this curve (or similar, per each backer layer/hypothetical section stack simulation), the end-user may select the desired radar correcting layers that provide values less than “T₁” in the preferred frequency range. The user can then take the real radar correcting layer that matches the permittivity and thickness of the computer identified optimum radar correcting layer (i.e., the selected radar correcting layer), and then apply the selected radar correcting layer to the back of the radar transmissive section of the vehicle/object. The end user can then identify to confirm that the radar transmission loss values of that particular radar transmissive section now meets the radar compliance requirement. As noted herein, the radar compliance requirement may be any value, but in certain cases will be representative of a transmission loss of no more than 5 dB, such as 3 dB, 2 dB, or 1 dB.

As noted above, it is not required in all cases that the number of layers in a Given section stack match the number of layers and values calculated for a given hypothetical section stack. The number of layers may be more or less in the Given section stack, and by comparison more or less in the hypothetical section stack. As long as the predicted or simulated radar transmission loss values match between the hypothetical section stack and compared Given section stack, the analyses disclosed herein will still work.

In this vein, TABLE 8, below, demonstrates that even if the Given section stack is made up of multiple layers, a hypothetical stack can be generated with fewer than the actual number of layers, and still achieve a good match to the radar loss of the Given section stack.

TABLE 8

| | | | | | | | | | | d_{BL} (μm) |
|---|---|---|---|---|---|---|---|---|---|---|
| | | | | | | | | | | rounded |
| Hypothetical | | | | | d_{substrate} | d_{basecoat} | RMSE | | d_{BL} | to nearest |
| Stack | ε′_{substrate} | ε″_{substrate} | ε′_{basecoat} | ε″_{basecoat} | (μm) | (μm) | (dB) | ε′_{BL} | (μm) | 100 μm |
| 1 | 2.291 | 0.0000 | 42.734 | 4.4037 | 2850 | 22.06 | 0.0008 | 4 | 490 | 500 |
| 2 | 2.411 | 0.0000 | 44.155 | 0.0827 | 2850 | 23.91 | 0.0038 | 4 | 417 | 400 |
| 3 | 3.229 | 0.0129 | 70.384 | 0.0002 | 2992 | 12.61 | 0.0024 | 3 | 13 | 0 |
| 4 | 2.727 | 0.0000 | 67.729 | 3.4338 | 2760 | 19.54 | 0.0027 | 4 | 320 | 300 |
| 5 | 2.707 | 0.0000 | 80.108 | 0.0000 | 2850 | 23.04 | 0.0181 | 4 | 216 | 200 |
| 6 | 2.498 | 0.0000 | 28.512 | 1.6728 | 2950 | 15.71 | 0.0005 | 3 | 475 | 500 |
| 7 | 2.536 | 0.0000 | 28.735 | 0.8839 | 2750 | 19.72 | 0.0014 | 2.5 | 681 | 700 |
| 8 | 2.876 | 0.0004 | 69.522 | 8.6489 | 2903 | 27.56 | 0.0004 | 4 | 101 | 100 |
| 9 | 2.487 | 0.0000 | 69.830 | 8.3443 | 2950 | 16.69 | 0.0139 | 4 | 259 | 300 |
| 10 | 2.304 | 0.0000 | 62.648 | 0.0000 | 2700 | 28.71 | 0.0266 | 4 | 549 | 500 |

The first six columns of Table 8 represent a smaller set of variables (fewer coating layers) relative to the Given section stacks of Table 1 (e.g., compared with Tables 4 and 5). In Table 8, the generalized reduced gradient non-linear method (simulator 420) was used to generate permittivity and thickness values for the hypothetical stacks, and the resulting radar transmission loss curves for these hypothetical stacks still match those of the Given section stacks in Table 1 to an RMSE of less than 0.03 dB. Using these hypothetical section stacks, the simulator 620 provides the thicknesses of the radar correcting layers shown in Table 8 that match very closely to those generated previously for the Given section stacks of Table 1 (see Table 2). Similarly, the radar correcting layers for the hypothetical stacks in Table 8 match exactly (except #10) to those in Table 2. Thus, in accordance with the present disclosure, it is not always necessary to model a Given section stack by a hypothetical stack with the same number of coatings layers to match the radar loss curve of the Given section stack to an RMSE better then 0.03 dB or less. Thus, as long as a generated hypothetical section stack in virtually any composition can generate radar transmission loss values sufficiently close to those measured for a Given section stack, the determined radar correcting layer that corrects the imperfectly layer-matching hypothetical section stack will still correct the radar transmission loss of the matched Given section stack in the same way.

In addition to the foregoing, which contemplates measurements taken over a large number of frequencies, the present disclosure can also be applied to situations in which only one or a select, small number of frequencies can be measured. For example, some radar measurement devices may be capable of emitting and detecting radar loss in a fairly narrow band, such as just 76.5 GHZ, or a range between 76 GHz and 81 GHz. In such a configuration in which a radar transmitter/receiver pair (e.g., the radar transmitter 220 and receiver 230 of FIG. 2B) is only capable of emitting one, two, or three frequencies instead, additional or strategies further described below may be employed. Such strategies can be used to still gather multiple data sets by measuring transmission loss against a transmissive section stack and a series of one or multiple different radar calibration layers, the arrangement of which varies by thickness.

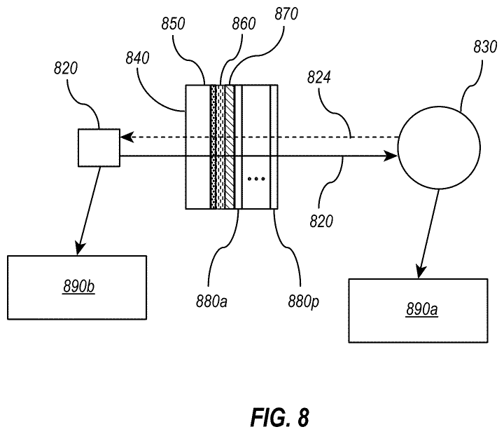

Thus, in contrast with FIGS. 1-7 and the corresponding description, which identify hypothetical section stacks and backer layers based on data taken over multiple frequencies, FIGS. 8-10 can be used to characterize hypothetical section stacks and radar correcting layers essentially as a function of measurements taken over different thicknesses of front calibration layers over a single or limited frequency. That is, a plot can be generated by varying calibration layer thickness rather than frequency. The end goal in FIGS. 8-10 is essentially the same: identifying a hypothetical section stack that can approximate a transmission loss curve for a Given section stack.

For example, FIG. 8 shows a block diagram of a simulation system 800 that measures radar transmission loss values with one or more front calibration layers 880a-880p at one (or limited) frequency. Reference numerals 820, 822, 824, 830, 840, 850, 860, 870, 890a and 890b may correspond to reference numerals 220, 222, 224, 230, 240, 250, 260, 270, 290a and 290b of FIG. 2B. Thus, descriptions for reference numerals 820, 822, 824, 830, 840, 850, 860, 870, 890a and 890b may be found in the corresponding descriptions of FIG. 2B above and different features of such numerals are described below. The front calibration layers 880a-880p will be understood as any arrangement of one (or a plurality) of calibration layers 880a (a . . . p).

In this configuration, the transmitter 820 may be able to emit radar and the receiver 830 may be able to measure radar transmission loss values at one, two, or three frequencies (e.g., 76.5 GHz or 79 GHz). In an example, the transmitter 820 and receiver 830 may be able to measure radar transmission loss values at one, two, or three frequencies but not over a range of frequencies (e.g., 60 GHz to 90 GHz with 0.1 or 1 GHz resolution).

To obtain measurement data in this configuration, a user may apply one or more front calibration layers 880a-880p to the front of the radar transmissive section of the vehicle including the given object substrate 840 and hypothetical section stack. As before, the illustrated hypothetical section stack includes a representation of a primary layer (inclusive of adhesion promoter and sealer) 850, the basecoat 860, and the clearcoat 870. The permittivity of each calibration layer will generally be held constant while thickness of each arrangement varies. The arrangements in turn may include calibration layers of the same thickness stacked together to achieve an added thickness, or may simply be thicker calibration layers in the first case. The user can, in turn, provide various arrangements of one or more calibration layers 880a-880p to the front (or back) of a given object transmissive section. In the illustrated case, “p” may be the maximum number of the calibration layers and may vary depending on the number of trial variables of the layers to be estimated. For example, when some trial variables of the layers in the hypothetical stacks are set to be constant, “p” can be lower than when all trial variables of the layers in the hypothetical stacks are not constant.

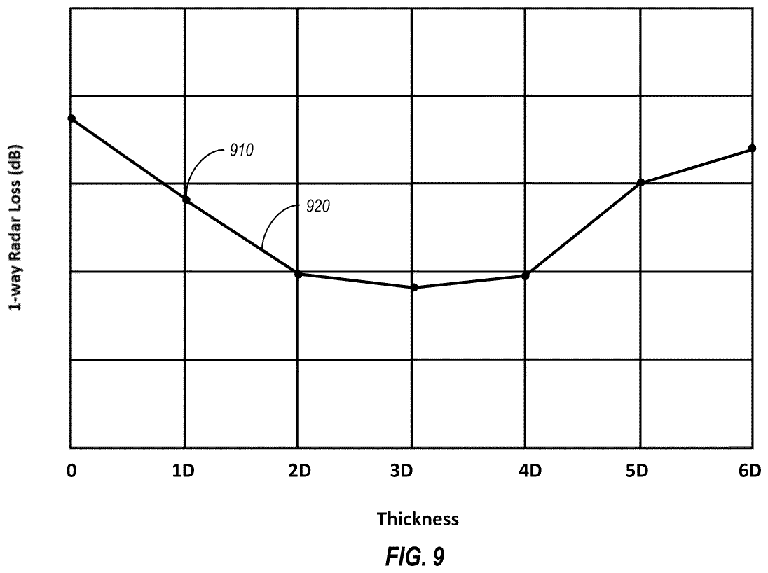

With this configuration of FIG. 8, the measured radar transmission loss values are illustrated in data plot 910 in FIG. 9, which plots radar transmission loss against variations in front calibration layer thickness, meaning in this case various arrangements of calibration layers (thereby varying thickness). When the thickness is zero (or no calibration layer is applied), the corresponding data point shown reflects the radar transmission loss value of the layers of the radar transmissive section without the calibration layers. Along the horizontal axis, “1D” represents the thickness of one calibration layer, “2D” represents the thickness of two calibration layers (whether multiple 1D thickness calibration layers, or a single, thicker calibration layer), and so forth. The number and/or thickness of calibration layers may vary depending on the number of trials needed to obtain enough data. Thus, even though the horizontal axis has “6D’ as the maximum, the horizontal axis may have “pD” where p is greater than 6.

The data plot 910 may be obtained by serially measuring radar transmission loss values by applying one additional calibration layer at a time up to “p” calibration layers. Or the data plot 910 may be obtained by serially measuring radar transmission loss values by applying an arrangement of one or more “p” calibration layers first and removing the arrangement (or part thereof) at a time until all calibration layers are removed. Thus, curve 920 fits to the data plot 910, and may be obtained via one or more curve-fitting methods.

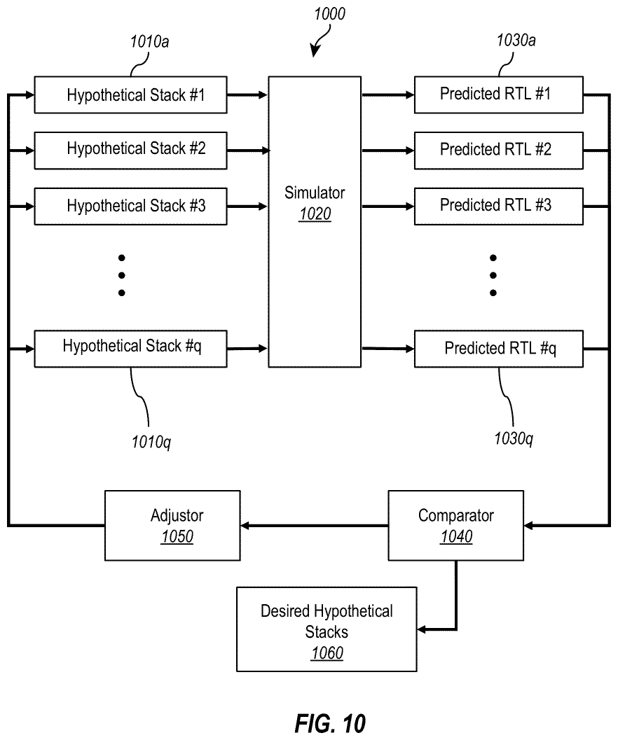

Based on the data plot 910 or the curve 920, one or more desired hypothetical stacks may be found by a simulation system 1000 of FIG. 10, which may include the same or alternative components to those already described for FIGS. 4 and/or 6. The simulation system 1000 may measure radar transmission loss values with one or more calibration layers at least one frequency (e.g., 76.5 GHz or 79 GHZ). The simulation system 1000 may include a simulator 1020, a comparator 1040, and an adjustor 1050. The simulator system 1000 may output one or more desired hypothetical stacks 1060.

With further reference to FIG. 10, the initial hypothetical stacks 1010a-1010q may include layer variables, for example, various layer variables corresponding to the Given section stacks as shown above in TABLE 1, in addition to a variable for the front calibration layer. The simulator 1020 may perform simulations for each hypothetical stack with application of zero through a maximum number of calibration layers at one frequency. The results of the simulator 1020 are simulated or predicted radar transmission loss values 1030a-1030q over thicknesses of the calibration layers. The comparator 1040 may compare the simulated radar transmission loss values 1030a-1030q with the measured radar transmission loss values 910.

In a case where the error or difference between the simulated radar transmission loss values 1030a-1030q with the measured radar transmission loss values 910 is less than another threshold value, the corresponding hypothetical stack may be outputted as a desired hypothetical stack 1060, which can be a good candidate for the radar transmissive section of the vehicle.

In a case where the error or difference between the simulated radar transmission loss values 1030a-1030q with the measured radar transmission loss values 910 is not less than the threshold value, the adjustor 1050 may adjust the trial variables of the layers. These adjustments generally involve adjusting one or both of permittivity and thickness of each layer in a hypothetical section stack 1010a-1010q. In this adjustment, the generalized, reduced gradient non-linear method, the L-BFGS, L-BFGS-B, or any other readily available method may be employed to determine whether to increase or decrease each trial variable (e.g., varying each thickness and/or permittivity of each hypothetical section stack layer) until identifying a hypothetical stack that matches the measured values for the actual transmissive section and given arrangement of front calibration layers. Iteratively performing simulations, comparisons, and adjustments, the simulation system 1000 may be able to output desired hypothetical stacks 1060, which mimic the measurement data 910.

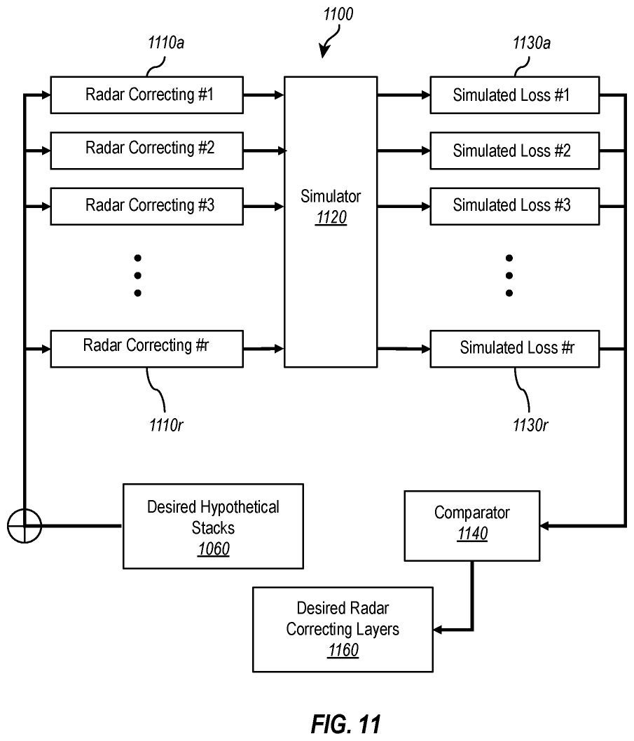

Just as previously described with respect to applying and measuring the effect of a radar correcting layer in FIGS. 1-7, upon identifying an applicable hypothetical stack, FIG. 11 shows that simulator 1120 can find a radar correcting layer that, in combination with the desired hypothetical stacks 1060, provides for an acceptable radar transmission loss. In this regard, a simulation system 1100, as illustrated in FIG. 11, may include a simulator 1120 and a comparator 1140. The simulator 1120 may add one or more radar correcting layers 1110a-1110r to each of the desired hypothetical stacks 1060, perform simulations on the combinations, and output simulated radar transmission loss values 1130a-1130r. Each simulated radar transmission loss value can then be compared by the comparator 1140 with a threshold value required by the radar compliance requirement. In a case where the radar transmission loss is less than the threshold value, the system can then provide as output the determined, ideal radar correcting layer. One will appreciate that not every radar correcting layer/backer layer will help a given hypothetical transmissive section achieve a compliant minimization of radar transmission loss. Whether a radar correcting layer enables a given hypothetical transmissive section is largely dependent on one or both of the radar correcting layer's inherent permittivity of the material composition, and its thickness.

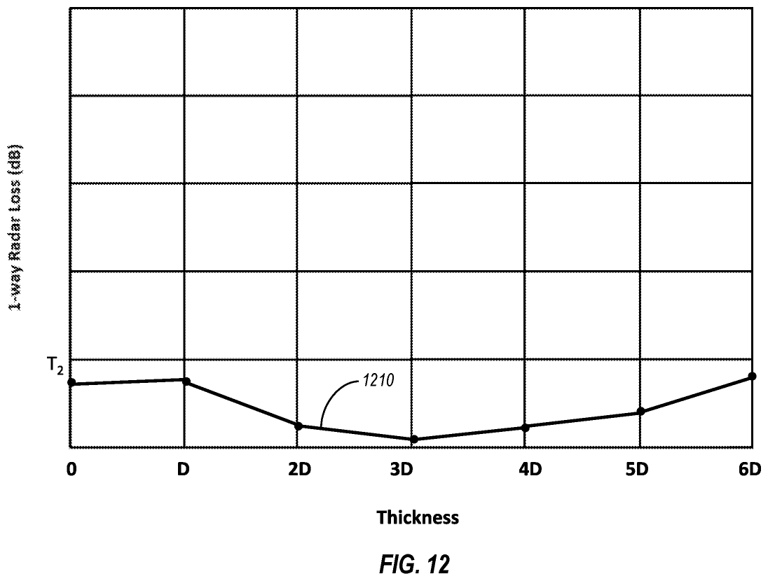

FIG. 12 illustrates a curve 1210 of radar transmission loss values after simulations with applied backer layers, and T₂ representing the threshold value for the radar compliance requirement. As illustrated, after application of a desired radar correcting layer, which has been found based on the simulation system 1100, the curve 1210 is positioned below the threshold value T₂ at the frequency (e.g., 76.5 GHz or 79 GHZ). Then, the end-user may select one of the desired radar correcting layers. The end user may then apply the selected radar correcting layer to the back of the radar transmissive section of the vehicle so that the radar transmission loss values meet the radar compliance requirement.

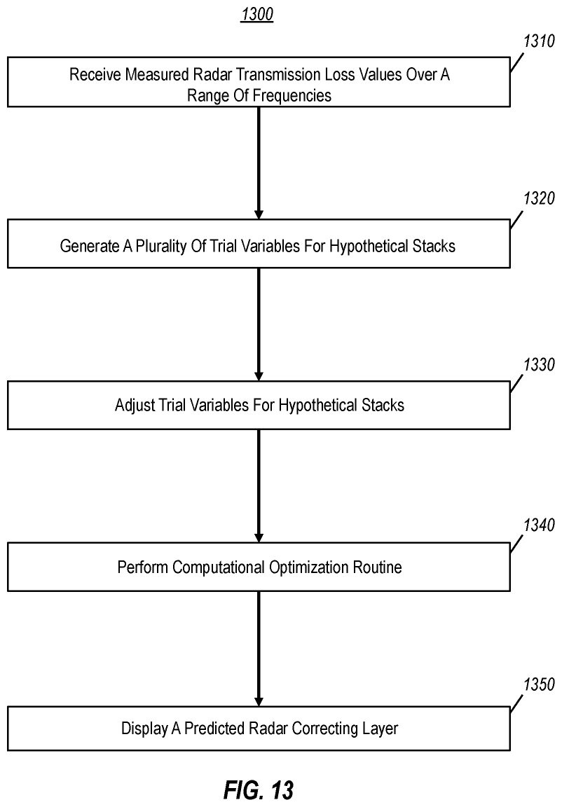

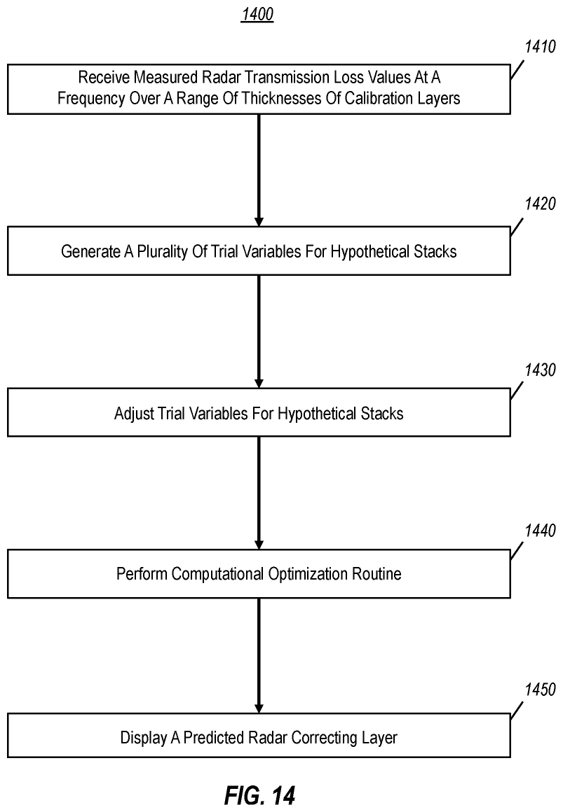

As described above, FIGS. 1A through 12 provide multiple components, modules, and schematics as part of a system for providing workflows at a body shop to provide a list of radar correcting layer(s) to make a newly coated vehicle section to meet a radar compliance requirement for a radar transceiver equipped for driver assistance systems in a vehicle. The present disclosure can also be described in terms of one or more methods for accomplishing similar results. Along these lines, FIGS. 13 and 14 illustrate various methods for making a newly coated section of a vehicle radar complaint. The acts and steps illustrated in FIGS. 13 and 14 are discussed below with reference to the components and modules illustrated in FIGS. 1A-12.

For example, FIG. 13 illustrates a method 1300 of making a newly coated vehicle section to be radar compliant by applying a desired radar correcting layer to the radar transmissive section (e.g., the repaired radar transmissive section 145 of FIG. 1B) of a vehicle, which has been repaired. Act 1310 can include receiving measurement radar transmission loss values over a range of frequencies. The radar transmitter 220 and radar receiver 230 of FIG. 2B may be utilized in measuring radar transmission loss values over the range of frequencies. The simulation system 400 of FIG. 4 may receive the measured radar transmission loss values.

The range of frequencies may range from 1 GHz to 300 GHz, such as from 60 GHz to 90 GHz, from 76 GHz to 81 GHz, from 76 GHz to 77 GHz or 77 GHz to 81 GHz. The measurement may be made by unit of 1 GHz, 0.1 GHZ, or any other suitable frequency interval.

In addition, FIG. 13 shows that the method 1300 can comprise an act 1320 of generating a plurality of trial variables for hypothetical stacks by the simulation system (e.g., 400 of FIG. 4). The trial variables may include thickness and permittivity values of each layer of the hypothetical stack corresponding to the radar transmissive section. For example, the hypothetical radar transmissive section may include the substrate 240, the primer layer 250, the basecoat 260, and the clearcoat 270 of FIG. 2B. Each of the layers has an associated set of permittivity and thickness values over the range of frequencies.

The act 1320 further can include performing simulations for each hypothetical radar transmissive section by the simulator (e.g., the simulator 420 of FIG. 4).

Additionally, in a case where the simulated transmission loss values of each hypothetical stack are not the same as the measured radar transmission loss values within an acceptable error range (e.g., using RMSE), FIG. 13 shows that the method 1300 can comprise an act 1330 of adjusting trial variables for each hypothetical stack. The trial variables may be a thickness and permittivity of the substrate (substrate), the adhesion promoter and sealer or primer layer (A&S), the basecoat (basecoat), and the clearcoat (clearcoat) of the layers in the hypothetical stacks. In an example, the adjustor (e.g., the adjustor 450 of FIG. 4) may set some of the trial variables to be constant and vary the other trial variables.

The adjustor may employ the generalized reduced gradient non-linear method, the LBFGS, L-BFGS-B, or any other suitable methods to determine—whether to increase or decrease the trial variables. By determining an increasing or decreasing direction for the trial variables, the adjusted trial variables of the hypothetical stacks may have radar transmission loss values close to the measured radar transmission loss values within a RMSE of less than the threshold.

In response to iterative adjustments, FIG. 13 shows that the method 1300 can comprise act 1340 of performing computational optimization routine. During the computational optimization routine, the simulator (e.g., the simulator 620 of FIG. 6) may apply a number of radar correcting layers, whose thicknesses and permittivities are different from each other, to the adjusted hypothetical stacks, and perform simulations to generate simulated radar transmission loss values based on the combination of the adjusted hypothetical stacks and the radar correcting layers.

In a case when the simulated radar transmission loss values are less than a threshold for the radar compliance requirement (e.g., 3.0 dB or less, 2.0 dB, 1.5 dB, 1 dB. 0.5 dB or any other appropriate threshold value required in the situation), such radar correcting layers are determined to be predicted radar correcting layers.

Further, FIG. 13 also shows that the method 1300 can comprise an act 1350 of displaying the predicted radar correcting layers. Based on the displayed predicted radar correcting layers, the engineer/manager/mechanic/end user (e.g., the end user 130 of FIG. 1A or 1B) may select one of the predicted radar correcting layers and may apply the selected predicted radar correcting layer to the back of the radar transmissive section so that the combination meets the radar compliance requirement. In at least one aspect, display of the predicted radar correcting layer(s) can comprise displaying instructions for additive manufacturing of the radar correcting layer(s), including any material composition requirements.

In addition to the foregoing, FIG. 14 illustrates that a method 1400 of predicting a radar correcting layer can comprise an act 1410 of receiving measured radar transmission loss values at a frequency over a range of thicknesses of calibration layers. The frequency may be 76.5 GHz or 79 GHz, and the range of frequencies may be from 1 GHz and 300 GHz, from 60 and 90 GHz, from 76 GHz and 81 GHz, from 77 GHz to 81 GHz, or any other suitable ranges.

The act 1410 further can include applying one or more calibration layers to a radar transmissive section (e.g., the repaired radar transmissive section 145 of FIG. 1B) of a physical object (e.g., the vehicle 140 of FIG. 1B). The radar transmissive section comprises a substrate and a plurality of coating layers applied to the substrate. The plurality of coating layers can include an adhesion promoter and sealer or primer layer (A&S), a basecoat (basecoat), and a clearcoat (clearcoat) in any number or type of arrangements. In one example, each of the one or more calibration layers has the same permittivity value and the same thickness value. In other examples, one or both of the permittivity and thickness value can be varied. The radar transmission loss value data of combinations of the radar transmissive section and one or more calibration layers are received by a simulation system 1000 of FIG. 10.

The measured radar transmission loss value data can include radar transmission loss values at the frequency with zero, one, two, . . . , and “p” numbers of calibration layers being applied thereon. Thereby, the measured radar transmission loss value data may be plotted over thicknesses of the calibration layers, as illustrated in FIG. 9

Additionally, FIG. 14 shows that the method 1400 can also include an act 1420 of generating a plurality of predicted transmissive loss values from a plurality of trial variables in the form of permittivity values and thickness values. In particular, the simulation system 1000 of FIG. 10 generates a plurality of hypothetical stacks to mimic the radar transmissive section, and the simulator 1020 of the simulation system 1000 performs simulations to generate radar transmission loss values based on combinations of each hypothetical stack and the plurality of calibration layers. The calibration layers may be applied to the front or back of the hypothetical stacks.

Further, FIG. 14 shows that the method 1400 can include an act 1430 of adjusting trial variables for the hypothetical stacks. After the simulations by the simulator 1020, the differences between the simulated radar transmission loss values and the measured radar transmission loss values are greater than a threshold, corresponding hypothetical stacks are not considered to correspond to the radar transmissive section of the physical object. In this case, the adjustor 1050 of FIG. 10 adjusts the trial variables in the form of permittivity values and thickness values of the hypothetical stacks. The adjustor 1050 may employ the generalized reduced gradient non-linear method, the LBFGS, L-BFGS-B, or any other suitable methods to determine—whether to increase or decrease the trial variables. By increasing or decreasing the trial variables, the adjusted hypothetical stacks may have radar transmission loss values close to the measured radar transmission loss values within a RMSE of less than the threshold, which may be 0.1 dB, 0.01 dB, or 0.001 dB. When the difference between the predicted radar transmission loss values and the measured radar transmission loss values is less than the threshold, the corresponding desired hypothetical stacks are considered appropriate to model the radar transmissive section of the physical object.

In addition to the adjustments, FIG. 14 shows that the method 1400 can comprise act 1440 of performing computational optimization routine via another simulation system (e.g., the simulation system 1100 of FIG. 11). The simulator (e.g., the simulator 1120 of FIG. 11) also performs simulations over combinations of the desired hypothetical stacks and a plurality of radar correcting layers to generate radar transmission loss values. The comparator (e.g., the comparator 1140 of FIG. 11) compares the generated radar transmission loss values with another threshold for the radar compliance requirement, which, as noted throughout this disclosure may be any value, but will typically be set at a radar transmission loss of no more than 5.0 dB, such as no more than 3.0 dB or less, 2.0 dB or less, 1.5 dB, 1 dB, or 0.5 dB or less.

The comparator then determines that one or more particular radar correcting layers, when combined with a particular section stack, cause the section stack to have a predicted radar transmission loss value that is less than the desired threshold (e.g., less than 5.0 dB, or 3.0 dB, etc.), and thus are considered as desired or optimal radar correcting layers.

After determining the predicted radar correcting layers, FIG. 14 shows that the method 1400 can comprise an act 1450 of providing one or more desired or predicted radar correcting layers to an end-user. The desired radar correcting layers may be displayed on a display screen. The desired radar correcting layer could be a set of precise properties of radar correcting layer in terms of composition, thickness, permittivity values, and so forth as described herein. Similarly or alternatively, the displayed radar correcting layer may be based on a closest match between a predicted radar correcting layer and a library of radar correcting layers. For example, using the data from Table 2, the library may comprise a set of radar correcting layers that are at preset thickness and/or permittivities, such as instead of displaying 500 μm instead of 493 μm, or a collection of radar correcting layers differing by thickness at every 100 μm. Based on the displayed predicted radar correcting layers, the end-user may select one of the desired radar correcting layers (i.e., what is listed, or a closest match) and the engineer/manager/mechanic/end user (e.g., the end user 130 of FIG. 1A or 1B) may apply the selected radar correcting layer(s) to the back of the radar transmissive section of the physical object so that the combination meets the radar compliance requirement.

The present disclosure can also be practiced with respect to more traditional facilities in the form of roofed buildings, such as vehicle body shops. The present disclosure (in particular principles of artificial intelligence) can further be used to identify a particular color, or even quality of a color match, such as may be used in automotive and residential coating matches. Still further, the present disclosure can be used in suggesting potential radar correcting layers to make the newly coated section of an object radar compliant. One will appreciate therefore that principles of the present disclosure can be applied not just to identifying of potential candidate colors, but also to measuring radar transmission loss value and confirming radar compliance of applied one or more radar correcting layers with the newly painted section of an object.

The present disclosure may comprise or utilize a special-purpose or general-purpose computer system that can include computer hardware, such as, for example, one or more processors and system memory, as discussed in greater detail below. The scope of the present disclosure also can include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose- or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the disclosure may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that can include one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

In view of the foregoing, the present disclosure may be embodied in multiple different configurations, as outlined above, and further described below in view of the following aspects.

For example, in a first aspect, a computer-implemented method may include receiving, at a computer system, radar transmission loss values corresponding to a radar transmission loss measurement of a radar transmissive section of an object, wherein the received radar transmission loss values comprise measurements taken of a radar signal passed through the radar transmissive section over a range of frequencies from 1 GHz to 300 GHz; generating a plurality of trial variables in the form of permittivity values and thickness values corresponding to a hypothetical radar transmissive section, the hypothetical radar transmissive section comprising a hypothetical section stack having an associated set of radar transmission loss values within the range of frequencies from 1 GHz and 300 GHz; adjusting one or more of the trial variables to create a set of predicted radar transmission loss values through the hypothetical section stack over a range of frequencies from 1 GHz to 300 GHz, wherein the predicted versus measured radar transmission loss values are within a Root Mean Square Error (RMSE) of less than 0.1 dB; using the one or more adjusted trial variables, performing a computational optimization routine via the computer system to predict a property of a radar correcting layer, such that the predicted radar correcting layer, when added to the hypothetical section stack, reduces a predicted radar transmission loss of the hypothetical stack to meet a radar compliance requirement; and generating output instructions for displaying the predicted radar correcting layer to an end-user. In a second aspect, in the computer-implemented method as recited in the first aspect, the range of frequencies is taken from 60 GHz to 90 GHz.

In a third aspect, in the computer-implemented method as recited in any of the preceding first through second aspects, generating output instructions further comprises displaying, on a digital display, the predicted radar correcting layer. In a fourth aspect, in the computer-implemented method as recited in any of the preceding first through third aspects, the hypothetical radar transmissive section comprises a hypothetical substrate with a hypothetical coating layer applied thereto. In a fifth aspect, in the computer-implemented method as recited in the fourth aspect, the hypothetical radar transmissive section comprises a hypothetical substrate with multiple coating layers applied thereto. In a sixth aspect, in the computer-implemented method as recited in any of the preceding first through fifth aspects, the hypothetical radar transmissive section comprises a hypothetical uncoated substrate. In a seventh aspect, in the computer-implemented method as recited in any of the preceding first through sixth aspects, the object is a vehicle.

In an eighth aspect, in the computer-implemented method as recited in the seventh aspect, the vehicle is an unmanned vehicle or drone. In a ninth aspect, in the computer-implemented method as recited in any of the preceding first through second aspects, the radar compliance requirement corresponds to a threshold value of acceptable radar transmission loss of no more than 5 dB, such as 3 dB, 2 dB, or 1 dB within a range of frequencies of from 76 GHz to 81 GHz. In a tenth aspect, in the computer-implemented method as recited in any of the preceding first through ninth aspects, the radar compliance requirement corresponds to a threshold value of acceptable radar transmission loss of no more than 5 dB, such as 3 dB, 2 dB, or 1 dB within a range of frequencies of from 76 GHz to 77 GHz or 77 GHz to 81 GHz. In an eleventh aspect, in the computer-implemented method as recited in any of the first through tenth aspects, the method further includes displaying an indicium for a predicted set of one or more radar correcting layers that most closely match the predicted radar correcting layer; wherein the indicium is selected from a library of discrete radar correcting layers that, when applied to the hypothetical substrate, enables the hypothetical substrate to meet the radar compliance requirement.

In a twelfth aspect, the computer-implemented method as recited in the eleventh aspect further includes displaying the indicium for the predicted radar correcting layer as a combination of multiple, discrete radar correcting layers. In a thirteenth aspect, in the computer-implemented method as recited in the twelfth aspect, each of the multiple, discrete radar correcting layers comprises a different thickness and/or permittivity from each other. In a fourteenth aspect, in the computer-implemented method as recited in any of the preceding first through thirteenth aspects, adjusting the one or more trial variables comprises adjusting an arrangement of the corresponding hypothetical coating layers about the hypothetical radar transmissive section. In a fifteenth aspect, in the computer-implemented method as recited in any of the first through fourteenth aspects, adjusting the one or more trial variables comprises adjusting one or both of (i) a thickness value, and (ii) a permittivity value.

In a sixteenth aspect, the computer-implemented method as recited in any of the preceding first through fifteenth aspects can further include: generating a plurality of hypothetical section stacks and a predicted radar transmission loss curves for each generated hypothetical section stack in the plurality; and identifying, for each of the plurality of hypothetical section stacks, a predicted radar transmission loss curve that fits a radar transmission loss curve corresponding to the measured transmission loss values over the set of measured frequencies with a RMSE of less than 0.1 dB, such as less than 0.01 dB, or less than 0.001 dB. In a seventeenth aspect, in the computer-implemented method as recited in any of the first through sixteenth aspects, the signal is transmitted by a radar transmitter from one side of the radar transmissive section to a radar receiver on an opposing side of the vehicle section. In an eighteenth aspect, in the computer-implemented method as recited in any of the first through seventeenth aspects, the signal is transmitted and received on the same side of the radar transmissive section.

In addition to the foregoing, a nineteenth aspect of the disclosure includes a computer-implemented method comprising: curve fitting, at a computer system, a set of measured radar transmission loss values for a radar signal sent through a radar transmissive section of a vehicle as measured over a range of frequencies; curve fitting, at the computer system, a plurality of hypothetical radar transmission loss curves over the range of frequencies for a plurality of radar transmission loss trials, wherein each radar transmission loss trial represents a set of trial variables in the form of permittivity values and thickness values corresponding to a set of various hypothetical coating layers that are arranged about a hypothetical substrate of the hypothetical radar transmissive section, the set of various hypothetical coating layers and the hypothetical substrate forming a hypothetical section stack having an associated radar transmission loss curve over the range of frequencies; comparing the curve fit of the measured radar transmission curve over the range of frequencies with any of the hypothetical radar transmission curves over the range of frequencies to identify a closest match therebetween, as quantified by a root mean square error; using the adjusted trial variables that generate the closest match curve, performing a computational optimization routine via the computer system to predict a property of a radar correcting layer that, when added to the hypothetical section stack, reduces the calculated radar transmission loss of the hypothetical section stack to meet a radar compliance requirement; displaying, on a digital display, the predicted radar correcting layer.

In a twentieth aspect, in the computer-implemented method as recited in the twentieth, wherein comparing the measured transmission loss curve to the hypothetical curves further comprises ensuring that the root mean square error for the closest match is from 0 dB and 0.1 dB, such as less than 0.01 dB, or less than 0.001 dB.

Furthermore, a twenty first aspect of the present disclosure may include a system having: a processor, and a computer-readable storage medium, the computer-readable storage medium having stored thereon computer-readable instructions that, when executed, cause the system to perform the following: receive, at the computer system, radar transmission loss values corresponding to a radar transmission loss measurement of a radar transmissive section of an object, wherein the received radar transmission loss values are measured over a range of frequencies from 1-300, such as 60 GHz to 90 GHz; generate a plurality of trial variables in the form of permittivity values and thickness values corresponding to a hypothetical radar transmissive section, the hypothetical radar transmissive section forming a hypothetical section stack having an associated set of radar transmission loss values within the range of frequencies; adjust one or more of the trial variables to create a set of calculated radar transmission loss values through the hypothetical section stack within the range of frequencies, wherein the calculated versus measured radar transmission loss values are within a RMSE of less than 0.1 dB; use the adjusted trial variables, perform a computational optimization routine via the computer system to predict a property of a radar correcting layer, such that the predicted radar correcting layer, when added to the hypothetical section stack, reduces the calculated radar transmission loss to meet a radar compliance requirement; and provide an output of the predicted radar correcting layer to an end-user.

In a twenty second aspect, in the system as recited in the twenty-first aspect, the system is further configured to: send print instructions to an additive manufacturing printer; wherein the print instructions cause the additive manufacturing printer to print the predicted radar correcting layer.

Still further, a twenty-third aspect of the present disclosure includes a system having: a processor, and a computer-readable storage medium, the computer-readable storage medium having stored thereon computer-readable instructions that, when executed, cause the system to perform the following: receive radar transmission loss data over a measured frequency from 1-300 GHz, such as 60 GHz and 90 GHz for i) a radar transmissive section of a physical object, and ii) a plurality of arrangements of one or more calibration layers applied about the radar transmissive section, wherein the radar transmission section comprises a substrate and one or more coating layers applied thereto, and each calibration layer has a permittivity value that is the same; generate a plurality of predicted transmission loss values from a plurality of trial variables in the form of permittivity values and thickness values, the predicted transmission loss values corresponding to i) a hypothetical section stack, and to ii) the hypothetical section stack combined with each of the arrangements of one or more calibration layers, wherein the hypothetical section stack comprises a plurality of hypothetical coating layers applied to a hypothetical substrate of a hypothetical transmissive section of a hypothetical object; adjust one or more of the trial variables to create a calculated radar transmission loss value at the measured frequency for i) the hypothetical section stack, and ii) a combination of each arrangement of one or more calibration layers and the hypothetical section stack, wherein the calculated versus received radar transmission loss values are within a root mean square error of less than 0.1 dB; use the adjusted trial variables, perform a computational optimization routine via the computer system to predict a property of a radar correcting layer, such that the predicted radar correcting layer, when added to the hypothetical section stack, reduces the predicted radar transmission loss to meet a radar compliance requirement; and provide an output of the predicted radar correcting layer to an end-user.

In a twenty fourth aspect, in the system as recited in the twenty-third aspect, the measured frequency is a single frequency between 60 GHz and 90 GHz. In a twenty-fifth aspect, in the system as recited in any of the preceding twenty third through twenty fourth aspects, the measured frequency is a single frequency within the range of 76 GHz to 81 GHz. In a twenty-sixth aspect, in the system as recited in any of the preceding twenty third through twenty fifth aspects, at least one of the arrangements of one or more calibration layers comprises a single calibration layer, and at least a second arrangement comprises a plurality of the single calibration layers stacked together. In a twenty seventh aspect, in the system as recited in any of the preceding twenty third through twenty seventh aspects, each calibration layer of the plurality has the same permittivity, but a different thickness from one calibration layer to the next.

In addition to the foregoing, a twenty eight aspect of the present disclosure may include a computer-implemented method of determining a set of one of more radar correcting layers for addressing a radar transmission loss of a radar transmissive section of an object, comprising: receiving radar transmission loss data over a measured frequency between 1-300 GHz, such as 60 GHz and 90 GHz for i) a radar transmissive section of a physical object, and ii) a plurality of arrangements of one or more calibration layers applied about the radar transmissive section, wherein the radar transmission section comprises a substrate and one or more coating layers applied thereto, and each calibration layer has a permittivity value that is the same; generating a plurality predicted transmission loss values from a plurality of trial variables in the form of permittivity values and thickness values, the predicted transmission loss values corresponding to i) a hypothetical section stack, and to ii) the hypothetical section stack combined with each of the arrangements of one or more calibration layers, wherein the hypothetical section stack comprises a plurality of hypothetical coating layers applied to a hypothetical substrate of a hypothetical transmissive section of a hypothetical object; adjusting one or more of the trial variables to create a calculated radar transmission loss value at the measured frequency for i) the hypothetical section stack, and ii) a combination of each arrangement of one or more calibration layers and the hypothetical section stack, wherein the calculated versus received radar transmission loss values are within a root mean square error of less than 0.1 dB; using the adjusted trial variables, performing a computational optimization routine via the computer system to predict a property of a radar correcting layer, such that the predicted radar correcting layer, when added to the hypothetical section stack, reduces the predicted radar transmission loss to meet a radar compliance requirement; and providing an output of the predicted radar correcting layer to an end-user.

In a twenty-ninth aspect, in the computer-implemented method as recited in the twenty eight aspect, the measured frequency is a single frequency between 60 GHz and 90 GHz. In a thirtieth aspect, in the computer-implemented method as recited in any of the preceding twenty eighth through twenty ninth aspects, the measured frequency is a single frequency within the range of 76 GHz to 81 GHz. In a thirty first aspect, in the computer-implemented method as recited in any of the preceding twenty eighth through thirtieth aspects, at least one of the arrangements of one or more calibration layers comprises a single calibration layer, and at least a second arrangement comprises a plurality of the single calibration layers stacked together. In a thirty second aspect, in the computer-implemented method as recited in any of the preceding claims twenty eighth through thirst first aspects, each calibration layer of the plurality has the same permittivity, but a different thickness from one calibration layer to the next.

In a thirty third aspect, in any of the preceding first through thirty second aspects, measurement may be conducted using a radar transmitter or emitter positioned on one side of an object's section stack, with a detector or received positioned on an opposing side of the section stack. In a thirty third aspect, in any of the preceding first through thirty second aspects, trial values for a given hypothetical section stack may be generated, adjusted, and/or optimized using a transfer matrix method (TMM), which calculates or otherwise predicts the electromagnetic plane-wave reflection and transmission characteristics of the set of layers in any given hypothetical section stack, or even a given section stack, such as outlined by The Transfer-Matrix Method in Electromagnetics, T. G. Mackay and A. Lakhtakia, Principles of Optics, 7th (expanded) edition, M. Born and E. Wolf, Section 1.6, Handbook of Optics, Chapter 42, “Optical Properties of Films and Coatings”, J. A. Dobrowolski, and S. J. Byrnes, “Multilayer Optical Calculations,” the entire content of which is incorporated herein by reference.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

1. A computer-implemented method comprising:
receiving, at a computer system, radar transmission loss values corresponding to a radar transmission loss measurement of a radar transmissive section of an object, wherein the received radar transmission loss values comprise measurements taken of a radar signal passed through the radar transmissive section over a range of frequencies from 1 GHz to 300 GHz;
generating a plurality of trial variables in the form of permittivity values and thickness values corresponding to a hypothetical radar transmissive section, the hypothetical radar transmissive section comprising a hypothetical section stack having an associated set of radar transmission loss values within the range of frequencies from 1 GHz and 300 GHz;
adjusting one or more of the trial variables to create a set of predicted radar transmission loss values through the hypothetical section stack over a range of frequencies from 1 GHz to 300 GHz, wherein the predicted versus measured radar transmission loss values are within a Root Mean Square Error (RMSE) of less than 0.1 dB;
using the one or more adjusted trial variables, performing a computational optimization routine via the computer system to predict a property of a radar correcting layer, such that the predicted radar correcting layer, when added to the hypothetical section stack, reduces a predicted radar transmission loss of the hypothetical stack to meet a radar compliance requirement; and
generating output instructions for displaying the predicted radar correcting layer to an end-user.

2. The computer-implemented method as recited in claim 1, wherein the range of frequencies is taken from 60 GHz to 90 GHz.

3. The computer-implemented method as recited in claim 1, wherein generating output instructions further comprises displaying, on a digital display, the predicted radar correcting layer.

4. The computer-implemented method as recited in claim 1, wherein the hypothetical radar transmissive section comprises a hypothetical uncoated substrate.

5. The computer-implemented method as recited in claim 1, wherein the object is a vehicle.

6. The computer-implemented method as recited in claim 1, wherein the radar compliance requirement corresponds to a threshold value of acceptable radar transmission loss of no more than 5 dB, such as 3 dB, 2 dB, or 1 dB within a range of frequencies of from 76 GHz to 81 GHz.

7. The computer-implemented method as recited in claim 1, further comprising:
displaying an indicium for a predicted set of one or more radar correcting layers that most closely match the predicted radar correcting layer;
wherein the indicium is selected from a library of discrete radar correcting layers that, when applied to the radar transmissive section, enables the radar transmissive section to meet the radar compliance requirement.

8. The computer-implemented method as recited in claim 7, further displaying the indicium for the predicted radar correcting layer as a combination of multiple, discrete radar correcting layers.

9. The computer-implemented method as recited in claim 8, wherein each of the multiple, discrete radar correcting layers comprises a different thickness and/or permittivity from each other.

10. The computer-implemented method as recited in claim 1, wherein adjusting the one or more trial variables comprises adjusting one or both of (i) a thickness value, and (ii) a permittivity value.

11. The computer-implemented method as recited in claim 1, further comprising:
generating a plurality of hypothetical section stacks and a predicted radar transmission loss curves for each generated hypothetical section stack in the plurality; and
identifying, for each of the plurality of hypothetical section stacks, a predicted radar transmission loss curve that fits a radar transmission loss curve corresponding to the measured transmission loss values over the set of measured frequencies with a RMSE of less than 0.1 dB, such as less than 0.01 dB, or less than 0.001 dB.

12. A system comprising:
a processor, and a computer-readable storage medium, the computer-readable storage medium having stored thereon computer-readable instructions that, when executed, cause the system to perform the following:
receive radar transmission loss data over a measured frequency from 1-300 GHz, such as 60 GHz and 90 GHz for i) a radar transmissive section of a physical object, and ii) a plurality of arrangements of one or more calibration layers applied about the radar transmissive section, wherein the radar transmission section comprises a substrate and one or more coating layers applied thereto, and each calibration layer has a permittivity value that is the same;
generate a plurality of predicted transmission loss values from a plurality of trial variables in the form of permittivity values and thickness values, the predicted transmission loss values corresponding to i) a hypothetical section stack, and to ii) the hypothetical section stack combined with each of the arrangements of one or more calibration layers, wherein the hypothetical section stack comprises a plurality of hypothetical coating layers applied to a hypothetical substrate of a hypothetical transmissive section of a hypothetical object;
adjust one or more of the trial variables to create a calculated radar transmission loss value at the measured frequency for i) the hypothetical section stack, and ii) a combination of each arrangement of one or more calibration layers and the hypothetical section stack, wherein the calculated versus received radar transmission loss values are within a root mean square error of less than 0.1 dB;
use the adjusted trial variables, perform a computational optimization routine via the computer system to predict a property of a radar correcting layer, such that the predicted radar correcting layer, when added to the hypothetical section stack, reduces the predicted radar transmission loss to meet a radar compliance requirement; and
provide an output of the predicted radar correcting layer to an end-user.

13. The system as recited in claim 12, wherein the measured frequency is a single frequency from 60 GHz and 90 GHz, in particular from 76 GHz to 81 GHz.

14. The system as recited in claim 12, wherein, at least one of the arrangements of one or more calibration layers comprises a single calibration layer, and at least a second arrangement comprises a plurality of the single calibration layers stacked together.

15. The system as recited in claim 12, wherein each calibration layer of the plurality has the same permittivity, but a different thickness from one calibration layer to the next.

16. A computer-implemented method of determining a set of one of more radar correcting layers for addressing a radar transmission loss of a radar transmissive section of an object, comprising:
receiving radar transmission loss data over a measured frequency between 1-300 GHz, such as 60 GHz and 90 GHz for i) a radar transmissive section of a physical object, and ii) a plurality of arrangements of one or more calibration layers applied about the radar transmissive section, wherein the radar transmission section comprises a substrate and one or more coating layers applied thereto, and each calibration layer has a permittivity value that is the same;
generating a plurality predicted transmission loss values from a plurality of trial variables in the form of permittivity values and thickness values, the predicted transmission loss values corresponding to i) a hypothetical section stack, and to ii) the hypothetical section stack combined with each of the arrangements of one or more calibration layers, wherein the hypothetical section stack comprises a plurality of hypothetical coating layers applied to a hypothetical substrate of a hypothetical transmissive section of a hypothetical object;
adjusting one or more of the trial variables to create a calculated radar transmission loss value at the measured frequency for i) the hypothetical section stack, and ii) a combination of each arrangement of one or more calibration layers and the hypothetical section stack, wherein the calculated versus received radar transmission loss values are within a root mean square error of less than 0.1 dB;
using the adjusted trial variables, performing a computational optimization routine via the computer system to predict a property of a radar correcting layer, such that the predicted radar correcting layer, when added to the hypothetical section stack, reduces the predicted radar transmission loss to meet a radar compliance requirement; and
providing an output of the predicted radar correcting layer to an end-user.

17. The computer-implemented method as recited in claim 16, wherein the measured frequency is a single frequency between 60 GHz and 90 GHz.

18. The computer-implemented method as recited in claim 16, wherein the measured frequency is a single frequency within the range of 76 GHz to 81 GHz.

19. The computer-implemented method as recited in claim 16, wherein, at least one of the arrangements of one or more calibration layers comprises a single calibration layer, and at least a second arrangement comprises a plurality of the single calibration layers stacked together.

20. The computer-implemented method as recited in claim 16, wherein each calibration layer of the plurality has the same permittivity, but a different thickness from one calibration layer to the next.
